(19) United States
(12) Patent Application Publication
(10) Pub. No.: US 2018/0268383 A1
(43) Pub. Date: Sep. 20, 2018

(54) ELECTRONIC DEVICE AND METHOD FOR DETECTING ITEM IN DATA ASSOCIATED WITH WEB

(71) Applicant: SAMSUNG ELECTRONICS CO., LTD., Suwon-si (KR)

(72) Inventors: Younghoon Kim, Seongnam-si (KR); Hyunjoong Kim, Suwon-si (KR); Sang Chul Baek, Seoul (KR); Dong-Ho Jang, Hwaseong-si (KR)

(21) Appl. No.: 15/901,232

(22) Filed: Feb. 21, 2018

(30) Foreign Application Priority Data
Mar. 15, 2017 (KR) 10-2017-0032571

(51) Int. Cl. G06Q 20/08; G06F 17/30; G06Q 20/12; G06Q 20/32

(52) U.S. Cl. CPC G06Q 20/085; G06Q 20/3255; G06Q 20/12; G06F 17/30896

(57) ABSTRACT

An electronic device according to various example embodiments includes: a memory storing instructions; a wireless communication circuit; and at least one processor, electrically coupled to the memory and the wireless communication circuit, configured to execute the stored instructions to: receive, from a first external electronic device, a first message for indicating that a first transaction is completed; determine at least one web address including a domain name associated with the transaction, among a plurality of web addresses accessed, by the electronic device, during an interval determined based on a timing at which the first message is received; determine information regarding an item of the first transaction by parsing data regarding at least one web document associated with the at least one web address; and transmit, to the first external electronic device or a second external electronic device, information regarding the item of the first transaction.

### PRIORITY

The present application is based on and claims priority under 35 U.S.C. § 119 to an application filed in the Korean Intellectual Property Office on Mar. 15, 2017 and assigned Serial No. 10-2017-0032571, the contents of which are incorporated herein by reference in their entirety.

### BACKGROUND

### 1. Technical Field

Various example embodiments relate to an electronic device, and more particularly, to an electronic device for detecting an item in data associated with a web and/or a method thereof.

### 2. Description of the Related Art

With the development of digital technology, electronic devices having mobility and also having the capability to communicate and/or process information, such as personal digital assistants (PDAs), electronic schedulers, smartphones, tablet personal computers (PCs), or wearable devices, are widely used. Such electronic devices provide capturing, path finding, or a web interface, in addition to services such as voice communication, text messaging, or the like.

As communication technology develops, electronic transactions such as payment by a credit card, that is easier to carry than cash, are increasingly used. That is, users can pay for a specific item using a credit card or the like without needing to carry cash. Due to the convenience in the aspect of portability, electronic devices provided with a payment function are developing.

### SUMMARY

As users using on-line shopping with electronic devices such as smartphones are increasing, various marketing techniques for inducing users to buy products (or items) sold in on-line shopping malls are appearing. For example, on-line shopping malls provide electronic devices with information on items (or products) that they are selling through short message service (SMS) messages, multi-media message service (MMS) messages, chat of messengers, or emails. However, information provided by on-line shopping malls are just advertisement information that does not reflect users' preference.

To address the above-discussed deficiencies, it is an object of example embodiments to provide at least one or more of the advantages described below. Accordingly, the example embodiments of present disclosure provide an electronic device and/or a method for providing item information reflecting a user's preference and/or characteristics.

According to an example aspect of the present disclosure, there is provided an electronic device, including: a housing; a touchscreen display exposed through a portion of the housing; a wireless communication circuit; a processor (including processing circuitry) electrically connected to the display and the communication circuit; and a memory connected to the processor, wherein the memory stores a first application program configured to transmit transaction-related information to a first external server via the communication circuit, and further stores instructions that cause the processor to: at least temporarily store first information on web addresses that the electronic device accesses via the communication circuit; receive a user input via the display for executing a transaction using the first application program; upon receiving the user input, transmit second information associated with the transaction to the first external server via the communication circuit; access a web document associated with one of the web addresses immediately before or after transmitting the second information; parse the web document to obtain at least one item associated with the transaction; and transmit third information on one or more of the at least one item or one of the web addresses to the outside of the electronic device using the communication circuit.

According to another example aspect of the present disclosure, there is provided an electronic device including: a memory storing instructions; a wireless communication circuit; and at least one processor (including processing circuitry), electrically coupled to the memory and the wireless communication circuit, configured to execute the stored instructions to: receive, from a first external electronic device, a first message for indicating that a first transaction is completed; determine at least one web address including a domain name associated with the transaction, among a plurality of web addresses accessed, by the electronic device, during an interval determined based on a timing at which the first message is received; determine information regarding an item of the first transaction by parsing data regarding at least one web document associated with the at least one web address; and transmit, to the first external electronic device or a second external electronic device, information regarding the item of the first transaction.

According to another example aspect of the present disclosure, there is provided a server including: at least one processor (including processing circuitry); and a memory, coupled to the at least one processor, configured to store instructions to cause the at least one processor to: receive, from a plurality of electronic devices, information regarding a plurality of items associated with a transaction; and transmit, if a frequency that a first item is included in information received from the plurality of electronic devices during a predetermined period is greater than or equal to a reference value, information regarding the first item, wherein the information regarding the plurality of items are respectively transmitted from the plurality of electronic devices based on completing a transaction regarding each of the plurality of items in each of the plurality of electronic devices.

According to another example aspect of the present disclosure, there is provided a method of an electronic device including: at least temporarily storing first information on web addresses that the electronic device accesses via a communication circuit of the electronic device; receiving a user input via a display of the electronic device, for executing a transaction using a first application program; upon receiving the user input, transmitting second information associated with the transaction to a first external server via the communication circuit; accessing a web document associated with one of the web addresses immediately before or after transmitting the second information; parsing the web document to obtain at least one item associated with the transaction; and transmitting third information on one or more of the at least one item or one of the web addresses to the outside of the electronic device using the communication circuit.

According to another example aspect of the present disclosure, there is provided a method of an electronic device including: receiving, from a first external electronic device, a first message for indicating that a first transaction is completed; determining at least one web address including a domain name associated with the transaction, among a plurality of web addresses accessed, by the electronic device, during an interval determined based on a timing at which the first message is received; determining information regarding an item of the first transaction by parsing data regarding at least one web document associated with the at least one web address; and transmitting, to the first external electronic device or a second external electronic device, information regarding the item of the first transaction.

According to another example aspect of the present disclosure, there is provided a method of a server including: receiving, from a plurality of electronic devices, information regarding a plurality of items associated with a transaction; and transmitting, if a frequency that a first item is included in information received from the plurality of electronic devices during a predetermined period is greater than or equal to a reference value, information regarding the first item, wherein the information regarding the plurality of items are respectively transmitted from the plurality of electronic devices based on completing a transaction regarding each of the plurality of items in each of the plurality of electronic devices.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view showing an example of a network environment including an electronic device according to various example embodiments;

FIG. 2 is a block diagram of an electronic device according to various example embodiments;

FIG. 3 is a block diagram of a program module according to various example embodiments;

FIG. 4 is a view showing an example of a functional configuration of an electronic device according to various example embodiments;

FIG. 5 is a view showing an example of a system including an electronic device which performs a transaction according to various example embodiments;

FIG. 6 is a view showing an example of an operation of an electronic device according to various example embodiments;

FIG. 7 is a view showing an example of an operation of an electronic device determining information regarding an item based on web information according to various example embodiments;

FIG. 8 is a view showing an example of another operation of an electronic device determining information regarding an item based on web information according to various example embodiments;

FIG. 9 is a concept view to illustrate a method for determining a web address associated with a transaction from among a plurality of web addresses according to various example embodiments;

FIG. 10 is a concept view to illustrate a method for classifying web addresses by actions according to various example embodiments;

FIG. 11 is a concept view to illustrate an example of a common tag included in parsed data according to various example embodiments;

FIG. 12 is a view showing an example of an operation of an electronic device determining information regarding a reference item according to various example embodiments;

FIG. 13 is a view showing an example of a signal flow between a big data server determining information regarding a reference item and an electronic device according to various example embodiments;

FIG. 14 is a view showing an example of a signal flow among a big data server determining information regarding a reference item, a payment server, and an electronic device according to various example embodiments;

FIG. 15 is a view showing an example of a signal flow among an electronic device receiving a notification message, a big data server, and a payment server according to various example embodiments;

FIG. 16 is a view showing another example of a signal flow among an electronic device receiving a notification message, a big data server, and a payment server according to various example embodiments; and

FIG. 17 is a view showing an example of a screen of a notification message displayed on an electronic device according to various example embodiments.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of example embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various example embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element(s) (e.g., third element) may be interposed between them. In contrast, it may be understood that when an element (e.g., first element) is referred to as being “directly connected,” or “directly coupled” to another element (second element), there is no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific example embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude example embodiments of the present disclosure.

An electronic device according to various example embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various example embodiments, the wearable device may include at least one of an accessory type (e.g., a watch, a ring, a bracelet, an anklet, a necklace, a glasses, a contact lens, or a Head-Mounted Device (HIVID)), a fabric or clothing integrated type (e.g., an electronic clothing), a body-mounted type (e.g., a skin pad, or tattoo), and a bio-implantable type (e.g., an implantable circuit).

According to some example embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV®), a game console (e.g., Xbox® and PlayStation®), an electronic dictionary, an electronic key, a camcorder, and an electronic photo frame.

According to another example embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some example embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various example embodiments of the present disclosure may be a combination of one or more of the aforementioned various devices. The electronic device according to some example embodiments of the present disclosure may be a flexible device. Further, the electronic device according to an example embodiment of the present disclosure is not limited to the aforementioned devices, and may include a new electronic device according to the development of technology.

Hereinafter, an electronic device according to various example embodiments will be described with reference to the accompanying drawings. As used herein, the term “user” may indicate a person who uses an electronic device or a device (e.g., an artificial intelligence electronic device) that uses an electronic device.

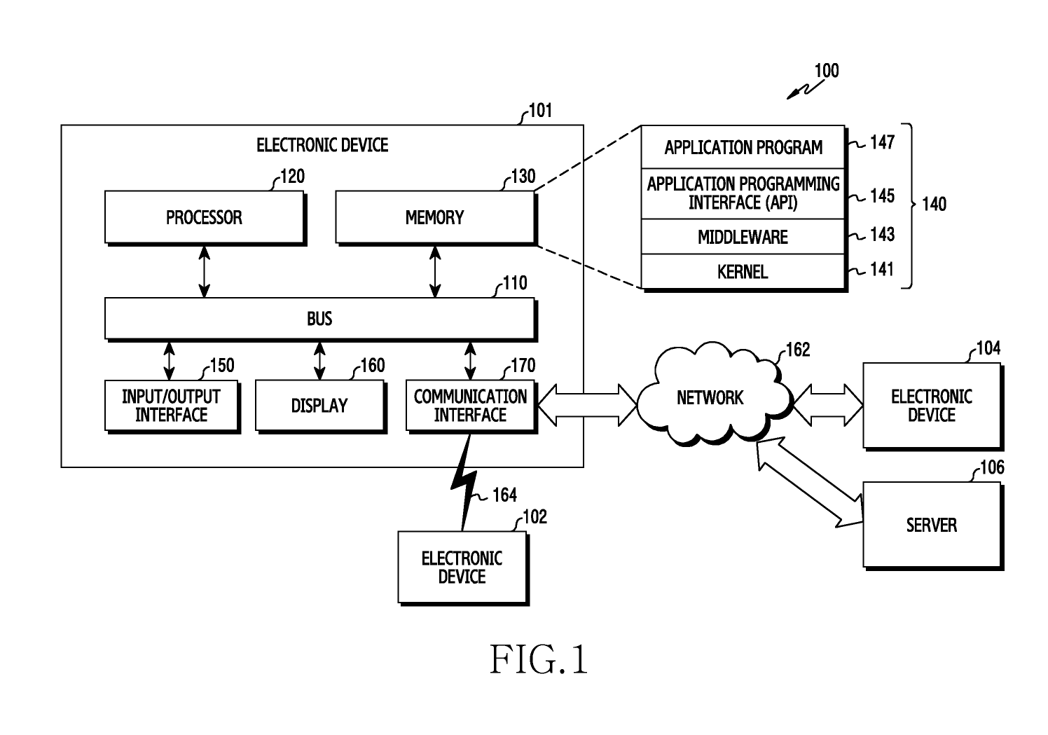

FIG. 1 illustrates a network environment including an electronic device according to various example embodiments of the present disclosure.

An electronic device 101 within a network environment, according to various example embodiments, will be described with reference to FIG. 1. The electronic device 101 may include a bus 110, a processor 120, a memory 130, an input/output interface 150, a display 160, and a communication interface 170. According to an example embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an example embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106). The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS). GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an example embodiment of the present disclosure, the server 106 may include a group of one or more servers. According to various example embodiments of the present disclosure, all or some of the operations performed in the electronic device 101 may be executed in another electronic device or a plurality of electronic devices (e.g., the electronic devices 102 and 104 or the server 106). According to an example embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

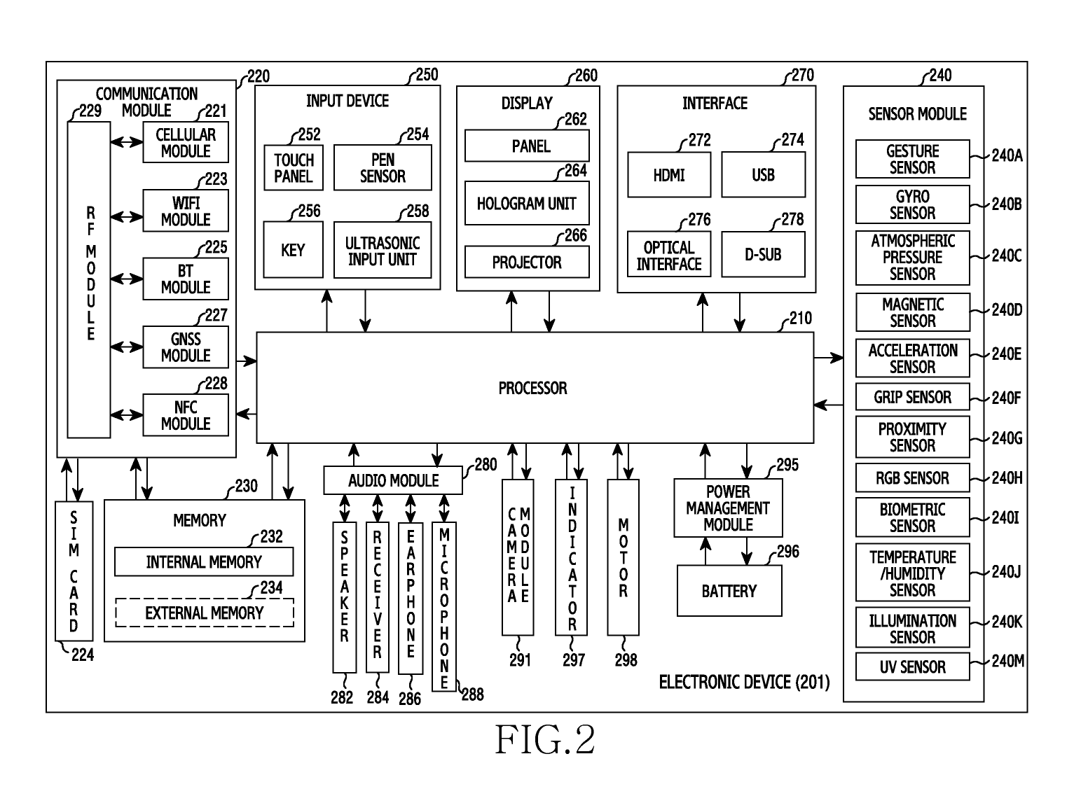

FIG. 2 is a block diagram of an electronic device according to various example embodiments of the present disclosure.

The electronic device 201 may include, for example, all or a part of the electronic device 101 shown in FIG. 1. The electronic device 201 may include one or more processors 210 (e.g., Application Processors (AP)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an example embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module 227, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to an example embodiment of the present disclosure, the cellular module 221 may distinguish and authenticate the electronic device 201 in a communication network using the subscriber identification module 224 (for example, the SIM card). According to an example embodiment of the present disclosure, the cellular module 221 may perform at least some of the functions that the AP 210 may provide. According to an example embodiment of the present disclosure, the cellular module 221 may include a communication processor (CP).

For example, each of the Wi-Fi module 223, the BT module 225, the GNSS module 227, and the NFC module 228 may include a processor for processing data transmitted/received through a corresponding module. According to an example embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another example embodiment of the present disclosure, at least one of the cellular module 221, the WIFI module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 240I, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an example embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an example embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an example embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an example embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO®.

Each of the above-described component elements of hardware according to the present disclosure may be configured with one or more components, and the names of the corresponding component elements may vary based on the type of electronic device. In various example embodiments, the electronic device may include at least one of the above-described elements. Some of the above-described elements may be omitted from the electronic device, or the electronic device may further include additional elements. Also, some of the hardware components according to various example embodiments may be combined into one entity, which may perform functions identical to those of the relevant components before the combination.

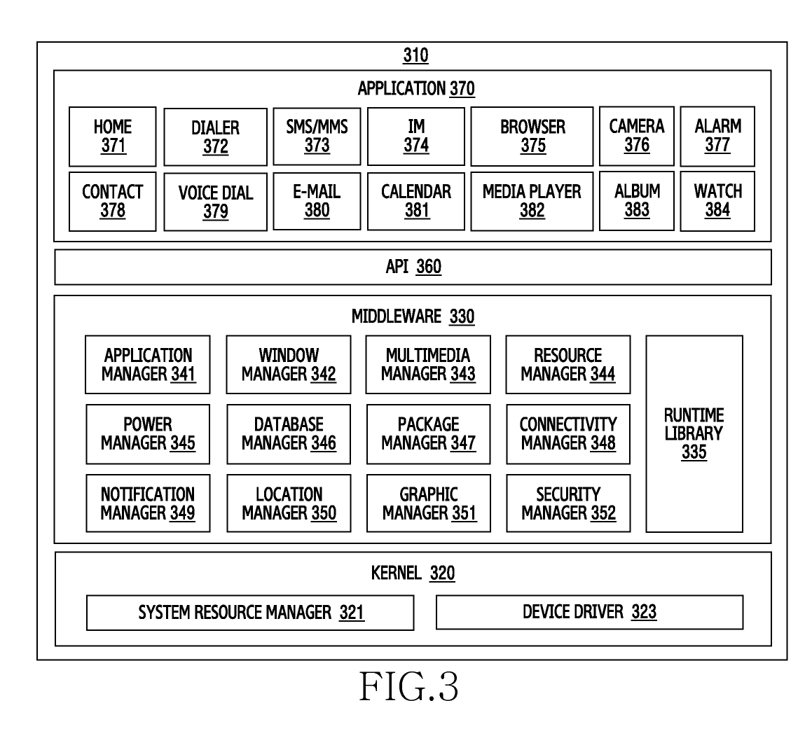

FIG. 3 is a block diagram of a program module according to various example embodiments of the present disclosure.

According to an example embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android®, iOS®, Windows®, Symbian®, Tizen®, Bada®, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an example embodiment of the present disclosure, the system resource manager 321 may include a process management unit, a memory management unit, a file system management unit, and the like. The device driver 323 may include, for example, a display driver, a camera driver, a Bluetooth® driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to an example embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an example embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar), or environment information (e.g., providing atmospheric pressure, humidity, or temperature information).

According to an example embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an example embodiment of the present disclosure, the applications 370 may include applications (e.g., a health care application of a mobile medical appliance or the like) designated according to an external electronic device (e.g., attributes of the electronic device 102 or 104). According to an example embodiment of the present disclosure, the applications 370 may include an application received from an external electronic device (e.g., the server 106, or the electronic device 102 or 104). According to an example embodiment of the present disclosure, the applications 370 may include a preloaded application or a third party application that may be downloaded from a server. The names of the components of the program module 310 of the illustrated example embodiment of the present disclosure may change according to the type of operating system.

According to various example embodiments, at least a part of the programming module 310 may be implemented in software, firmware, hardware, or a combination of two or more thereof. At least some of the program module 310 may be implemented (e.g., executed) by, for example, the processor (e.g., the processor 1410). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a unit of an integrated component element or a part thereof. The “module” may be a unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various example embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

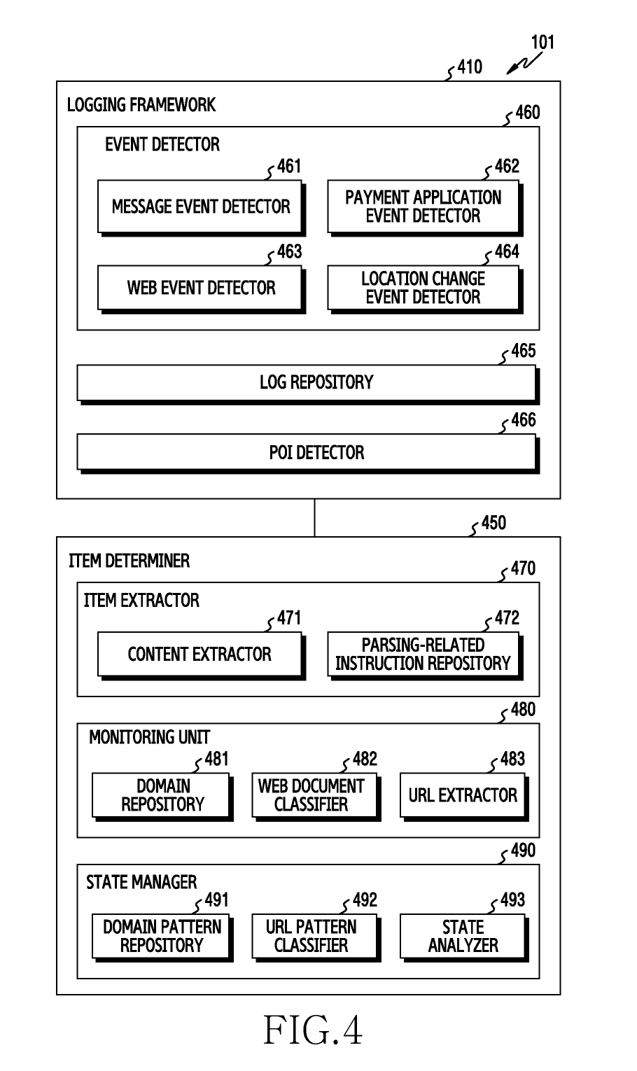

FIG. 4 is a view showing an example of a functional configuration of an electronic device according to various example embodiments. This functional configuration may be included in the electronic device 101 shown in FIG. 1 or an element (for example, the processor 120, the memory 130, etc.) included in the electronic device 101, such as in a processor(s) including processing circuitry.

Referring to FIG. 4, the electronic device 101 may include a logging framework 410 and an item determiner 450.

According to various example embodiments, the logging framework 410 may collect and manage an event log in the electronic device 101. In some example embodiments, the logging framework 410 may include an event detector 460, a log repository 465, and/or a point of interest (POI) detector 466.

In some example embodiments, the event detector 460 may receive information associated with an event occurring in the electronic device 101. The event detector 460 may include a message event detector 461, a payment application event detector 462, a web event detector 463, and/or a location change event detector 464.

The message event detector 461 according to various example embodiments may monitor a text message received at the electronic device 101. For example, the message event detector 461 may monitor an SMS message, an MIMS message, a chat message regarding a messenger application, a push message, etc. which is received at the electronic device 101. The message event detector 461 may determine whether the message is associated with a transaction by analyzing data included in the message. For example, the message event detector 461 may extract data included in the message by parsing the message. The message event detector 461 may provide information on the extracted or analyzed data to the log repository 465. The provided information may be stored in the log repository 465.

The payment application event detector 462 according to various example embodiments may monitor a mobile payment application stored in the electronic device 101. In some example embodiments, the payment application event detector 462 may monitor a state of the mobile payment application based on the mobile payment application being activated. For example, the payment application event detector 462 may monitor a message which is transmitted to another entity via the activated mobile payment application. In another example, the payment application event detector 462 may monitor a message which is received from another entity via the mobile payment application. The payment application event detector 462 may monitor whether a payment event occurs by monitoring the transmitted or received message. The payment application event detector 462 may determine whether the information is associated with a transaction by analyzing the monitored information. The payment application event detector 462 may provide the extracted or analyzed information to the log repository 465. The provided information may be stored in the log repository 465.

The web event detector 463 according to various example embodiments may monitor at least one web page which is displayed or executed by the electronic device 101. In some example embodiments, the web event detector 463 may monitor the at least one web page and may store (or temporarily store) the monitored at least one web page. The web event detector 463 may determine (or identify) whether the at least one web page is associated with a transaction. The web event detector 463 may provide information on the at least one web page to the log repository 465. The provided information may be stored in the log depository 465.

The location change event detector 464 according to various example embodiments may monitor a change in the location of the electronic device 101. For example, the location change event detector 464 may monitor the change in the location of the electronic device 101 using a sensor included in the electronic device 101 or a communication interface included in the electronic device 101. The location change event detector 464 may provide information on the change in the location of the electronic device 101 to the log repository 465. The provided information may be stored in the log repository 465.

The log repository 465 according to various example embodiments may store information which is detected by the message event detector 461, the payment application event detector 462, the web event detector 463, the location change event detector 464, or the POI detector 466. In some example embodiments, the log repository 465 may temporarily store the information.

The POI detector 466 according to various example embodiments may detect POI of the user of the electronic device 101 based on the information which is detected by the message event detector 461, the payment application event detector 462, the web event detector 463, and/or the location change event detector 464. The POI detector 466 may provide information on the detected POI to the log repository 465. The information on the detected POI may be stored in the log repository 465.

The item determiner 450 according to various example embodiments may determine what item is traded by the user of the electronic device 101 in association with the logging framework 410. In some example embodiments, the item determiner 450 may include an item extractor 470, a monitoring unit 480, or a state manager 490.

The item extractor 470 according to various example embodiments may specify what the item traded by the user of the electronic device 101 is or what the item associated with the electronic device 101 is, based on information provided by the logging framework 410. The item extractor 470 may include a content extractor 471 and/or a parsing-related instruction repository 472.

The content extractor 471 according to various example embodiments may extract a content or an item included in specific data based on instruction or rule information stored in the parsing-related instruction repository 472. For example, the content extractor 471 may extract a content or an item from a web document received from the logging framework by parsing the web document based on the instruction or rule information.

The parsing-related instruction repository 472 according to various example embodiments may store instruction or rule information for parsing information received from the logging framework 410. For example, the parsing-related instruction repository 472 may store data regarding a unit for parsing the provided information, a parsing method, etc. The parsing-related instruction repository 472 may provide the stored data to the content extractor 471.

The monitoring unit 480 according to various example embodiments may analyze that a transaction event occurring at the electronic device 101 is initiated, and may collect a log associated with the transaction. The monitoring unit 480 may include a domain repository 481, a web document classifier 482, and a uniform resource locator (URL) extractor 483.

According to various example embodiments, the domain repository 481 may store at least one URL of at least one web page associated with a transaction. For example, the domain repository 481 may store a URL of an on-line shopping mall associated with a transaction in order to determine a history of the electronic device 101 accessing main on-line shopping mall sites. In some example embodiments, the domain repository 481 may classify the at least one URL of the at least one web page according to a transaction. For example, the domain repository 481 may classify web pages associated with a transaction into a web page associated with an inquiry about an item, a web page associated with payment of an item, a web page displaying detailed information of a specific item, etc., and may store the web pages.

The web document classifier 482 according to various example embodiments may analyze a web document of a web page associated with the electronic device 101, and thereby determine what category the web page belongs to. In addition, the web document classifier 482 may classify the web document based on the result of determining.

According to various example embodiments, when a payment event associated with the electronic device 101 occurs, the URL extractor 483 may extract a web page history associated with a timing at which the payment event occurs. For example, when a payment-related message is received at the electronic device 101, the URL extractor 483 may extract a history of a web page that the electronic device 101 accesses during an interval which is determined based on the timing at which the payment-related message is received.

According to various example embodiments, when an action associated with a transaction is performed in the electronic device 101, the state manager 490 may analyze what action is being performed for the transaction.

The state manager 490 according to various example embodiments may include a domain pattern repository 491, a URL pattern classifier 492, and a state analyzer 493.

The domain pattern repository 491 according to various example embodiments may store URL patterns of the web pages associated with the transaction according to each action for the transaction. For example, the domain pattern repository 491 may store “www.amgon.com/items” as an action of providing summary information of a plurality of items, may store “www.amegon.com/detail” as an action of providing detailed information regarding a specific item, and may store “www.amegon.com/payment” as an action of paying for the specific item.

According to various example embodiments, when the electronic device 101 accesses an URL that is not stored in the domain pattern repository 491, the URL pattern classifier 492 may analyze the URL that is not stored, and may detect an action for a transaction. For example, when the electronic device 101 accesses “www.adjghlei.com/detail,” the electronic device 101 may determine that “www.adjghlei.com/detail” is associated with a transaction by parsing a web document associated with “www.adjghlei.com/detail,” and may detect an action of providing detailed information regarding a specific item.

The state analyzer 493 according to various example embodiments may analyze what the action for the transaction associated with the electronic device 101 is based on the information stored or detected in the domain pattern repository 491 or the URL pattern classifier 492. For example, the state analyzer 493 may determine that the current action for the transaction associated with the electronic device 101 is an action of searching detailed information or the current action for the transaction associated with the electronic device 101 is a payment action, based on the information provided from the domain pattern repository 491 or the URL pattern classifier 492.

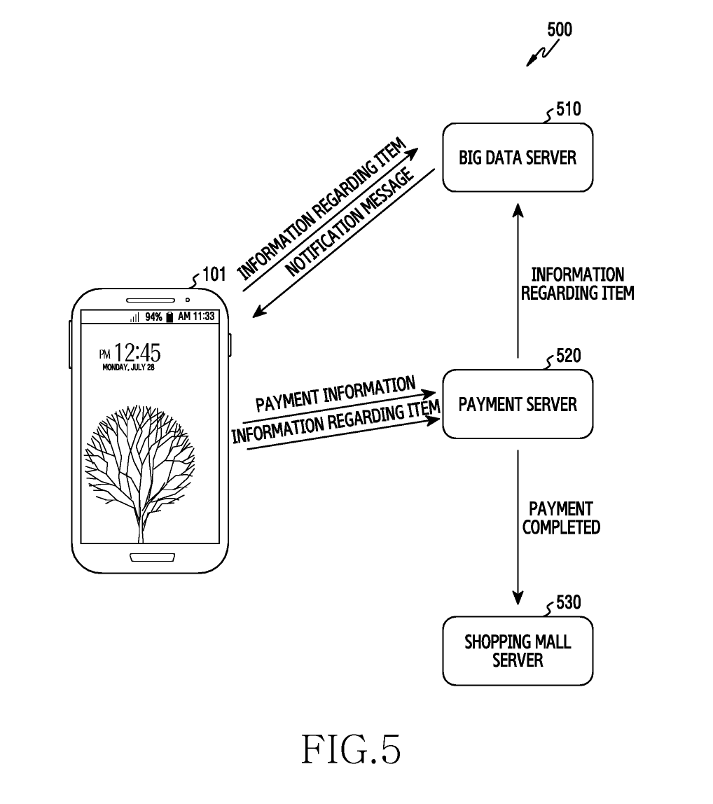

The operations performed by the logging framework 410 or the item determiner 450 according to various example embodiments will be described in detail below with reference to FIGS. 5 to 17.

In addition, it should be noted that the operations described as being executed by the electronic device 101 may be executed by the logging framework 410 or the item determiner 450 included in the electronic device 101.

The functional configuration of the electronic device 101 shown in FIG. 4 is merely an example for convenience of explanation and it should be noted that it is implemented in other changed formats. For example, unlike in FIG. 4, the electronic device 101 may perform the operations exemplified in FIG. 4 through the processor 120, the memory 130, and/or the communication interface 170 included in the electronic device 101.

An electronic device according to various example embodiments may include: a housing; a touchscreen display exposed through a portion of the housing; a wireless communication circuit; a processor electrically connected to the display and the communication circuit; and a memory connected to the processor, wherein the memory stores a first application program configured to transmit transaction-related information to a first external server via the communication circuit. The memory may further store instructions that cause the processor to: at least temporarily store first information on web addresses that the electronic device accesses via the communication circuit; receive a user input via the display for executing a transaction using the first application program; upon receiving the user input, transmit second information associated with the transaction to the first external server via the communication circuit; access a web document associated with one of the web addresses immediately before or after transmitting the second information; parse the web document to obtain at least one item associated with the transaction; and transmit third information on one or more of the at least one item or one of the web addresses to the outside of the electronic device using the communication circuit.

In some example embodiments, the instructions may cause the processor to transmit the third information to a second external server different from the first external server.

In some example embodiments, the web document may be in a hyper mark-up language (HTML) format.

In some example embodiments, the instructions may cause the processor to parse the web document using a rule-based method or a machine-learning based method.

In some example embodiments, the first information may include a URL.

In some example embodiments, the instructions may cause the processor to: receive fourth information via the communication circuit from the external server, wherein the fourth information is generated based at least partly on data associated with web addresses and items, the data being collected from a plurality of electronic devices that include the first application program; and provide a notification on the display, based on the fourth information.

In some example embodiments, the instructions may cause the processor to: determine whether a plurality of web addresses accessed by the electronic device are associated with the transaction; and at least temporarily store the first information on the web address associated with the transaction from among the plurality of web addresses.

An electronic device according to various example embodiments may include: a memory storing instructions; a wireless communication circuit; and at least one processor, electrically coupled to the memory and the wireless communication circuit, configured to execute the stored instructions to: receive, from a first external electronic device, a first message for indicating that a first transaction is completed; determine at least one web address including a domain name associated with the transaction, among a plurality of web addresses accessed, by the electronic device, during an interval determined based on a timing at which the first message is received; determine information regarding an item of the first transaction by parsing data regarding at least one web document associated with the at least one web address; and transmit, to the first external electronic device or a second external electronic device, information regarding the item of the first transaction.

In some example embodiments, the at least one processor may further be configured to execute the stored instructions to receive, from the second external electronic device, information regarding at least one reference item that is determined based on information regarding a plurality of items including the item transmitted from the electronic device. In addition, the at least one processor may further be configured to execute the stored instructions to receive, from the second external electronic device, a second message including information regarding a specific item that is determined based on information collected from a plurality of electronic devices. In addition, the electronic device may further include a display unit electrically coupled to the at least one processor, and the at least one processor may further be configured to execute the stored instructions to: determine whether the specific item is included in the at least one reference item; and display, via the display unit, information regarding the specific item, if the specific item is included in the at least one reference item. In addition, the information regarding the specific item that is displayed via the display unit includes data for establishing a second transaction regarding the specific item. In addition, the data for establishing the second transaction may include at least one of: data for indicating a web address providing the specific item; data for indicating an event associated with the specific item; data for indicating a price of the specific item; or data for indicating an image of the specific item.

In addition, the at least one processor may further be configured to execute the stored instructions: access a web page for a transaction regarding the specific item, based on detecting an input on the displayed information regarding the specific item; and display the web page that is accessed.

In addition, the second message may be transmitted, from the second external electronic device, if a frequency that the specific item is included in information collected from the plurality of electronic devices during a predetermined period is greater than or equal to a reference value.

In some example embodiments, the at least one processor may further be configured to execute the stored instructions to receive, from the second external electronic device, a second message including information regarding a specific item that is determined based on information collected from a plurality of electronic devices, and the second message may be transmitted, from the second external electronic device to the electronic device, based on determining that the specific item is included in at least one reference item that is determined based on information regarding a plurality of items including the item transmitted from the electronic device.

In some example embodiment, the at least one processor may be configured to execute the stored instructions to determine, by comparing at least one reference domain name associated with the transaction with domain names of the plurality of web addresses, the at least one web address having a domain name corresponding to the at least one reference domain name from among the plurality of web addresses, wherein the at least one reference domain name is pre-stored in the electronic device.

In some example embodiment, the at least one processor may be configured to execute the stored instructions to: identify words included in each of the domain names of the plurality of web addresses; determine whether a word generated by combining at least one of the identified words is included in at least one reference word pre-stored in the electronic device; and determine, based on determining that the word is included in the at least one reference word, a web address including a domain name including at least one word included in the word as the at least one web address.

In some example embodiment, the at least one processor may be configured to execute the stored instructions to: identify a tag included in the web document, by parsing data regarding the at least one web document; and determine information regarding an item of the first transaction, based on information included in the tag that is identified.

A server according to various example embodiments may include: at least one processor; and a memory, coupled to the at least one processor, configured to store instructions to cause the at least one processor to: receive, from a plurality of electronic devices, information regarding a plurality of items associated with a transaction; and transmit, if a frequency that a first item is included in information received from the plurality of electronic devices during a predetermined period is greater than or equal to a reference value, information regarding the first item, wherein the information regarding the plurality of items are respectively transmitted from the plurality of electronic devices based on completing a transaction regarding each of the plurality of items in each of the plurality of electronic devices.

FIG. 5 is a view showing an example of a system including an electronic device 101 (or 201) which executes a transaction according to various example embodiments.

Referring to FIG. 5, the system 500 may include an electronic device 101, a big data server 510, a payment server 520, and a shopping or shopping mall server 530.

The electronic device 101 may be a device that has mobility. The electronic device 101 may be referred to as a mobile station, a smartphone, a terminal, a station (STA), a user equipment, etc. according to example embodiments.

The electronic device 101 may be a fixed device. For example, the electronic device 101 may be, but not limited to, a desktop computer, a video game console, a smart television (TV), a home appliance provided with a communication function (for example, a refrigerator, a boiler, etc.), a mirror display, etc.

The electronic device 101 according to various example embodiment may communicate with another electronic device or another entity. For example, another entity may be a server such as the big data server 510, the payment server 520, the shopping mall server 530, etc. In some example embodiments, the electronic device 101 may communicate with another electronic device or another entity via a wired communication path. In some example embodiments, the electronic device 101 may communicate with another electronic device or another entity via a wireless communication path. For example, the wireless communication path may be a wireless fidelity (WiFi) path, a cellular communication path, or a path for proximity communication such as Bluetooth (BLE).

The electronic device 101 according to various example embodiments may display information received from another entity, such as the big data server 510, the payment server 520, the shopping server 530, etc., on the display 160 of the electronic device 101.

The electronic device 101 according to various example embodiments may execute various operations associated with a transaction. In some example embodiments, the electronic device 101 may execute a mobile application (for example, a Samsung pay application, or other pay application), and may perform communication for payment with an external electronic device using one of wireless communication circuits, while directly establishing wireless connection with the external electronic device (for example, a POS device). For example, the electronic device 101 may transmit payment-related information to the external electronic device(s) using one of NFC protocols, Bluetooth protocols, or multiple spanning tree (MST) protocols via at least one of the NFC module 228 or the BT module 225. However, the communication for payment is not limited thereto.

In some example embodiments, the electronic device 101 may transmit the payment-related information to the external electronic device in a non-communication scheme using a barcode or a quick response (QR) code, in addition to the communication scheme for payment.

Herein, the payment-related information may include token information or encryption information (for example, cryptogram).

In some example embodiments, the electronic device 101 may perform payment authentication to use a mobile payment service. For example, the electronic device 101 may receive a user input for biometric information (for example, fingerprint information, iris information, etc.), personal identification number (PIN) information, or signature information in order to perform the payment authentication. The electronic device 101 may perform the payment authentication prior to initiating an operation for performing payment for a transaction based at least partly on the received information. However, this should not be considered as limiting. When the electronic device 101 uses a mobile payment service, the electronic device 101 may receive information regarding the payment from a server which provides a payment service such as the payment server 520. However, this should not be considered as limiting.

In some example embodiments, when mobile payment is performed or payment authentication is performed before the mobile payment is performed, the electronic device 101 may obtain information which is generated as the payment or payment authentication is performed.

In some example embodiments, when the user of the electronic device 101 performs payment offline using a card (for example, a real credit card), the electronic device 101 may receive information regarding the offline payment (or a message indicating that a transaction of a specific items is completed) from a payment service server (for example, a card company server and/or a finance company server) such as the payment server 520, etc. For example, the electronic device 101 may receive, from the payment server 520, information regarding the payment (or a message indicating that the transaction is completed), which has a format like an SMS message, an MMS message, or a chat message of a messenger application. However, signaling or operation of the electronic device 101 is not limited thereto.

The electronic device 101 according to various example embodiments may determine what an item of a transaction associated with the electronic device 101 is. For example, the electronic device 101 may specify an item associated with the transaction from among a plurality of items provided to the electronic device 101, based at least partly on information regarding a plurality of webs that the electronic device 101 has accessed. In another example, the electronic device 101 may specify an item that is traded by the user of the electronic device 101 at an offline store, based on sensing data which is collected by the electronic device 101, or POI information which is determined by the electronic device 101 or received from a POI server managing POI. The operation of the electronic device 101 determining (specifying) the item of the transaction associated with the electronic device 101 will be described in detail below.

The electronic device 101 according to various example embodiments may transmit information regarding the item which is determined or specified by the electronic device 101 to another entity such as the big data server 510. The information regarding the item may include data indicating what the item is, such as a name of the item, an image of the item, etc. In addition, the information regarding the item may include data regarding a current price of the item.

According to various example embodiments, the information regarding the item may transmitted to the big data server 510 via various paths. For example, when the electronic device 101 performs payment through a mobile payment application stored in the electronic device 101, such as the Samsung pay, etc., the electronic device 101 may provide not only payment information (or information for completing the transaction) but also information regarding the item selected by the electronic device 101 to the payment server 520. The information regarding the item may be transmitted with the payment information or may be included in a separate message different from a message carrying the payment information and may be transmitted. The payment server 520 which receives the information regarding the item may provide or forward the information regarding the item to the big data server 510.

In another example, when the user of the electronic device 101 performs payments using a user's own card, etc., the electronic device 101 may provide the information regarding the item of the transaction associated with the electronic device 101 to the big data server 510.

The payment server 520 according to various example embodiments may be a server which provides a payment service. In some example embodiments, the payment server 520 may be a server which provides a mobile payment server such as Samsung pay. In some example embodiments, the payment server 520 may be a server which is managed by a bank or a finance company issuing a real card or an electronic card. In some example embodiments, the payment server 520 may be a server which is managed by a bank or a finance company buying a statement regarding a card transaction made at a store. In this case, the payment server 520 may be referred to as a buying server or a value add network (VAN).

The payment server 520 according to various example embodiments may generate a token corresponding to card information of a card, and may provide the token to the electronic device 510. In addition, the payment server 520 may search card information associated with the token in a transaction process.

The payment server 520 may perform identification regarding a card, etc. In addition, the payment server 520 may approve card payment when payment is made. For example, the payment server 520 may determine whether received card information is valid.

The payment server 520 may receive payment information (or information for completing a transaction) from the electronic device 101 or a POS device associated with the electronic device 101. The payment server 520 which receives the payment information may perform authentication and then approve the payment. After approving the payment, the payment server 520 may transmit a message indicating that the payment is completed to the shopping mall server 530.

The shopping mall server 530 according to various example embodiments may be a server which is managed by a shopping mall selling various items to users. The shopping mall server 530 may perform various operations associated with a transaction in association with the electronic device 101 or the payment server 520. For example, the shopping mall server 530 may provide information regarding various items which are sold at the shopping mall to the electronic device 101 to establish a transaction, and thereby induce the user of the electronic device 101 to buy. In another example, the shopping mall server 530 may provide price information of an item which is need to be paid to the payment server 520. In still another example, the shopping mall server 530 may receive information indicating that payment for the item or transaction of the item is completed from the payment server 520. However, this should not be considered as limiting.

According to various example embodiments, the big data server 510 may process information which is caused by a transaction associated with at least one of the electronic device 101, the payment server 520, or the shopping mall server 530. For example, the big data server 510 may store or update information regarding an item which is provided from the electronic device 101 or the payment server 520.

According to various example embodiments, the information regarding the item may include data for determining what the item is, such as a name of the item, a trademark of the item, an image of the item, etc. In addition, the information regarding the item may include data regarding a source where the item is being sold, such as OOO shopping mall, XX mart, etc. In addition, the information regarding the item may include data regarding a price of the item. In addition, the information regarding the item may include information regarding a period during which a promotion for the item is done.

In some example embodiments, the big data server 510 may determine information regarding preference of the user of the electronic device 101 based on the stored or updated information. Since the stored or updated information is determined based on the information regarding the item which is transmitted from the electronic device of the user, such as the electronic device 101, the big data server 510 may determine information regarding the preference of the user of the electronic device 101 without being limited to a specific seller (for example, XX shopping mall, OO mart, etc.). In other words, the big data server 510 may generate information regarding real preference of the user of the electronic device 101.

In some example embodiments, the big data server 510 may determine and store an item that is preferred by the user of the electronic device 101 based on the determined information regarding the user's preference. In addition, the big data server 510 may provide information regarding the item preferred by the user of the electronic device 101 to at least one of the electronic device 101, the payment server 520, or the shopping mall server 530.

In some example embodiments, the big data server 510 may monitor or analyze the information regarding the item, which is received from the payment server 520 or the electronic device 101. The big data server 510 may transmit a notification message to the electronic device 101 according to the result of monitoring or analyzing. For example, the big data server 510 may determine that a frequency of receiving information on the same item during a predetermined interval is greater than or equal to a reference value, based on the result of monitoring or analyzing. The big data server 510 may transmit, to the electronic device 101, a notification message including information regarding the item that has the frequency of reception greater than or equal to the reference value, based on determining that the frequency is greater than or equal to the reference value. In another example, the big data server 510 may determine that a difference between a current price of a specific item and a previous price of the specific item is greater than or equal to a reference value, based on the result of monitoring or analyzing. The big data server 510 may transmit a notification message including information regarding the specific item to the electronic device 101, based on determining that the difference is greater than or equal to the reference value. The operation of transmitting the notification message, which is performed by the big data server 510, is not limited thereto. According to example embodiments, the notification message may be multicasted or unicasted to each of the electronic devices.

According to example embodiments, the big data server 510 and the payment server 520 may be implemented by using one apparatus.

As described above, the electronic device 101 according to various example embodiments may determine information regarding an item of a transaction, and may provide the determined information regarding the item to the big data server 510. In other words, the electronic device 101 may provide the user with a service of higher availability through the operations of determining and providing the information regarding the item.

In addition, the big data server 510 according to various example embodiments may store and update information regarding an item which is provided from electronic devices such as the electronic device 101, and thereby grasp preferences of the user of each of the electronic devices. In addition, the big data server 510 may provide information regarding the users' preferences to the electronic devices. In addition, the big data server 510 may analyze or monitor the information regarding the item which is provided from electronic devices such as the electronic device 101, and thereby provide a notification message including information regarding an item which is substantially meaningful to the respective electronic devices such as the electronic device 101.

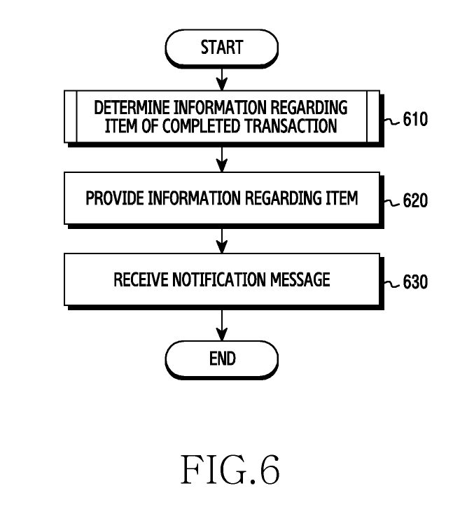

FIG. 6 is a view showing an example of an operation of an electronic device according to various example embodiments. This operation may be performed by the electronic device 101 (or 201) shown in FIG. 1 or an element of the electronic device 101 (or 201) such as the processor 120 (or 210), etc.

Referring to FIG. 6, in operation 610, the electronic device 101 (for example, the processor 120, etc.) may determine information regarding an item of a completed transaction. When the user of the electronic device 101 trades an item at an on-line site or an off-line store using a credit card or a mobile payment application of the electronic device 101, the electronic device 101 may receive a message indicating that the transaction of the item is completed from a first external electronic device such as the payment server 520. The message indicating that the transaction of the item is completed may include information regarding payment for the item (or information regarding a result of payment for the item). For example, the message indicating that the transaction of the item is completed may include data regarding a name of the item, data regarding a price of the item, data regarding a source selling the item, data regarding a date at which the transaction is completed, data for identifying a means used for the payment (for example, a part or entirety of a card number of the card used for payment), data regarding the total amount of money paid by the means for paying during a configured period (for example, one month), etc.

In some example embodiments, the electronic device 101 may determine information regarding the item of the transaction based on data included in the received message. For example, the electronic device 101 may obtain data regarding a source selling the item (for example, GOM mart), data regarding a price of the item (for example, 17,800 won or $25), data regarding a name of the item (for example, spicy Toppokki, bananas, or cooler), etc. by parsing the data included in the received message. However, a method for obtaining the data included in the received message is not limited thereto.

The electronic device 101 may determine whether it is possible to specify the item of the transaction using the data obtained based on the received message. When it is possible to specify the item of the transaction using the obtained data, the electronic device 101 may determine the information regarding the item of the transaction by specifying the item of the transaction based on the obtained data.

When it is not possible to specify the item of the transaction using the obtained data, the electronic device 101 may specify the item of the transaction through various operations. In some example embodiments, when it is not possible to specify the item of the transaction using the obtained data, the electronic device 101 may perform web search using the obtained data. The electronic device 101 may specify the item of the transaction based on information derived by the web search.

In some example embodiments, when it is not possible to specify the item of the transaction using the obtained data, the electronic device 101 may specify the item of the transaction based on information regarding a plurality of webs that the electronic device 101 accesses during an interval which is determined based on a timing at which the message is received. For example, when the message is received at 4:23 p.m. on January 19, 20XX, the electronic device 101 may refer to information regarding webs that the electronic device 101 has accessed from 4:13 p.m. to 4:23 p.m. on January 19, 20XX, which is stored in the memory 130 of the electronic device 101 or a buffer of the electronic device 101. The electronic device 101 may specify the item of the transaction based on the referred information regarding the webs.

In some example embodiments, when it is not possible to specify the item of the transaction using the obtained data, the electronic device 101 may specify the item of the transaction based on at least one of POI information or sensing information which is collected by the sensor module of the electronic device 101.

In some example embodiments, the POI information may include data regarding a place corresponding to the location of the electronic device 101. For example, the POI information may include information regarding a current region or place (for example, a store, an institution, a facility, or a building) where the electronic device 101 is positioned. In another example, the POI information may include data regarding a name of the store where the electronic device 101 is positioned. The data included in the POI information is not limited thereto.

In another example embodiment, the POI information may include data regarding a place associated with payment. For example, when the electronic device 101 performs payment using a mobile payment application, the POI information may include data regarding a place where the electronic device 101 is positioned at a timing at which the payment is performed (or the message is received). However, data included in the POI information is not limited thereto.

In still another example embodiment, the POI information may include data regarding a location within a predetermined range (or distance) from a location where the payment is performed. For example, the POI information may include data regarding a region within a 10-meter radius from the location where the electronic device 101 performs the payment. However, data included in the POI information is not limited thereto.

In one example embodiment, the sensing information may include data which is sensed at the place where the electronic device 101 is positioned. For example, the sensing information may include data which is sensed using at least one of at least one communication circuit in the electronic device 101 or at least one sensor (including sensing circuitry) in the electronic device 101 at the place where the electronic device 101 is positioned. For example, the sensing information may include data which is collected using one or more of a cellular radio signal received at the place where the electronic device 101 is positioned, a Wi-Fi signal, a Bluetooth signal, an NFC signal, or other radio signals. In another example, the sensing information may include data included in a signal which is received from a device (an access point (AP) for Wi-Fi communication, a beacon, etc.) positioned (or placed) inside the place where the electronic device 101 is positioned, a device (for example, a base station, etc.) positioned in the proximity of the electronic device 101, a global positioning system (GPS) satellite, etc. However, data included in the sensing information is not limited thereto.

According to example embodiments, the electronic device 101 may store (or temporarily store) the information regarding the item of the transaction in the electronic device 101.

In operation 620, the electronic device 101 (for example, the processor 120, etc.) may provide the information regarding the item to another entity. Another entity may include at least one of the big data server 510, the payment server 520, and/or the shopping mall server 530.

The information regarding the item which is provided to another entity may include data specifying (or identifying) the item. For example, the information regarding the item may include data regarding a name of the item, data regarding a trademark of the item, an image of the item, data regarding a current price of the item, data regarding a discount rate of the item, data regarding a promotion period of the item, data regarding a source selling the item, etc. However, data included in the information regarding the item is not limited thereto.

The electronic device 101 may transmit the information regarding the item in order to provide reference data for determining preference of the user of the electronic device 101.

In some example embodiments, the electronic device 101 may transmit the information regarding the item to the payment server 520 in order to provide reference data for determining the preference of the user of the electronic device 101. In one example embodiment, the information regarding the item may be included in a message which is transmitted from the electronic device 101 to the payment server 520 and includes payment information used for paying for the item, and may transmitted with the message. In another example embodiment, the information regarding the item may be included in a separate message different from the message that is transmitted from the electronic device 101 to the payment server 520 and includes the payment information, and may be transmitted. In this case, a timing of transmitting the message including the information regarding the item may be configured diversely. For example, the message including the information regarding the item may be transmitted immediately before or after the message including the payment information is transmitted. In another example, the message including the information regarding the item may be transmitted after a time configured by the electronic device 101 elapses from the timing at which the message including the payment information is transmitted. The payment server 520 which receives the information regarding the item may provide the information regarding the item to the big data server 510.

In some example embodiments, the electronic device 101 may transmit the information regarding the item to the big data server 510 in order to provide reference data for determining preference of the user of the electronic device 101.

The big data server 510 which receives the information regarding the item may determine a preference item of the user of the electronic device 101, based on the information regarding the item and information regarding a previous item which is received from the electronic device 101 (or via the payment server 520). The big data server 510 may transmit information regarding the determined preference item to the electronic device 101. According to example embodiments, the information regarding the preference item may be referred to as information regarding a reference item. In some example embodiments, the information regarding the reference item may be transmitted to the electronic device 101 in every predetermined period. In some example embodiments, the information regarding the reference item may be transmitted to the electronic device 101 every time the reference item is changed. In some example embodiments, the information regarding the reference item may be transmitted based on a request message being received from the electronic device 101.

The electronic device 101 may receive the information regarding the reference item from the big data server 510. In addition, the electronic device 101 may store the information regarding the reference item.

The electronic device 101 may transmit the information regarding the item, such that the big data server 510 can determine whether to transmit a notification message including information regarding an item which currently raises an issue. In other words, the electronic device 101 may transmit the information regarding the item, such that the big data server 510 can monitor what item is increasingly paid for.

In operation 630, the electronic device 101 (for example, the processor 120, etc.) may receive a notification message from the big data server 510.

The notification message may include various data. For example, the notification message may include identification data of an item which is increasingly bought (for example, a name of the item, a brand name of the item, a trademark of the item, an image of the item, etc.), data indicating a selling source of the item which is increasingly bought (for example, an address of an offline store, an address of an on-line web site, etc.), price data of the item which is increasingly bought, a discount rate of the item which is increasingly bought, data regarding a promotion period of the item which is increasingly bought, etc.

The notification message may be transmitted from the big data server 510 to the electronic device 101 based on a specific condition being satisfied. The specification condition may be variously set. For example, the big data server 510 may monitor or analyze information regarding items which is received from each of the electronic devices such as the electronic device 101. When a frequency of receiving information of the same item during a predetermined interval is greater than or equal to a reference value as the result of monitoring, the big data server 510 may transmit the notification message. In another example, the big data server 510 may compare current price data of the item, which is included in the information regarding the item received from the electronic device, and previous price data of the item, which is stored in the big data server 510. When a difference between the current price data and the previous price data is greater than or equal to a threshold value, the big data server 510 may transmit the notification message. In another example, the big data server 510 may compare a previous frequency of receiving information regarding a specific item and a current frequency of receiving the information regarding the specific item. When a difference between the previous frequency of receiving and the current frequency of receiving is greater than or equal to a threshold value, the big data server 510 may transmit the notification message. However, a condition for transmitting the notification message is not limited thereto.

The notification message may be transmitted in various transmitting methods. In some example embodiments, the notification message may be unicasted to each of the electronic devices. When the notification message is unicasted to the electronic device 101, the electronic device 101 may display the notification message on the display 160 of the electronic device 101. In addition, the electronic device 101 which displays the notification message may display a screen providing information for buying the item on the display 160, based on data indicating the source of the item, included in the notification message, in response to a user's input on the displayed notification message being detected. In other words, in response to a user's input on the displayed notification message being detected, the electronic device 101 may access a web site, etc. selling the item included in the notification message.

In some example embodiments, the notification message may be broadcasted (or multicasted) to electronic devices associated with the big data server 510. When the notification message is multicasted, the electronic device 101 may perform an additional operation for processing the received notification message, differently to when the notification message is unicasted. For example, the electronic device 101 may determine whether the item included in the notification message corresponds to reference data stored in the electronic device 101, by comparing the data regarding the item included in the notification message and the reference data stored in the electronic device 101. When the item included in the notification message corresponds to the reference data (or when the item included in the notification message is included in the reference data), the electronic device 101 may display the notification message on the display 160. On the other hand, when the item included in the notification message does not correspond to the reference data (or when the item included in the notification message is not included in the reference data), the electronic device 101 may not display the notification message on the display 160. When the notification message is not displayed on the display 160, the electronic device 101 may perform the additional operation for processing information regarding the notification message. For example, the electronic device 101 may temporarily store the information regarding the notification message in the electronic device 101, or may discard the notification message. However, the additional operation of the electronic device 101 processing the information regarding the notification message is not limited thereto.

As described above, the electronic device 101 according to various example embodiments may specify what the item bought by the user of the electronic device 101 is, and may provide information regarding the specified item (or information for identifying the specified item) to another entity.

In addition, the big data server 510 according to various example embodiments may recognize preference of users of a plurality of electronic devices based on information regarding items received from the plurality of electronic devices such as the electronic device 101, etc. In addition, the big data server 510 may provide information regarding the recognized users' preference to the plurality of electronic devices as reference data. In addition, the big data server 510 may grasp what item is increasingly bought at the present time or for what item an event is ongoing, without being limited to a specific source, based on the information regarding the items received from the plurality of electronic devices. The big data server 510 may transmit a notification message including the information regarding the item to the plurality of electronic devices associated with the big data server 510, such that the users of the plurality of electronic devices can shop the items. In addition, the big data server 510 may provide a service to a source associated with the big data server 510 and providing or selling items (for example, a shopping mall site, etc.).

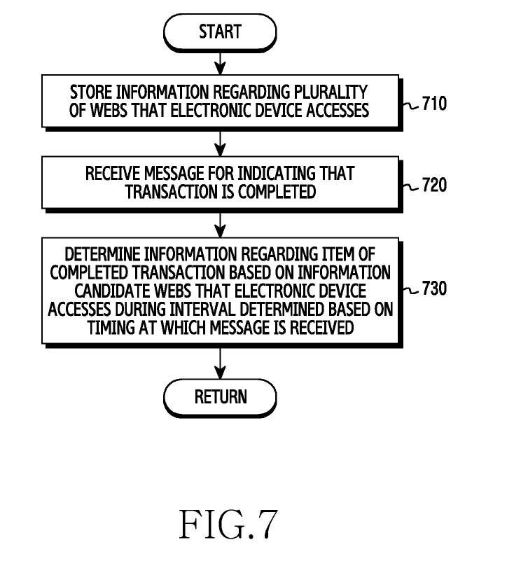

FIG. 7 is a view showing an example of an operation of an electronic device determining information regarding an item based on web information according to various example embodiments. This operation may be performed by the electronic device 101 (or 201) shown in FIG. 1, or an element of the electronic device 101 (or 201) such as the processor 120 (or 210), etc.

Referring to FIG. 7, in operation 710, the electronic device 101 (for example, the processor 120) may store information regarding a plurality of webs that the electronic device 101 accesses.

In some example embodiments, the electronic device 101 may temporarily store the information regarding the plurality of webs that the electronic device 101 accesses. In one example embodiment, the electronic device 101 may store the information regarding the plurality of webs that the electronic device 101 accesses in the memory 130, etc. of the electronic device 101 during a predetermined period. The predetermined period may have a different length according to configuration of the electronic device 101. For example, the electronic device 101 may configure a length of the predetermined period according to a length corresponding to an amount of load processed by the electronic device 101. In another example, the electronic device 101 may configure the length of the predetermined period according to a length configured by the user of the electronic device 101. However, a method for configuring the length of the predetermined period is not limited thereto. In another example embodiment, the electronic device 101 may store the information regarding the plurality of webs that the electronic device 101 accesses in the memory 130, etc. according to user's setting. For example, when the user of the electronic device 101 sets the electronic device 101 to discard the information regarding the plurality of webs, stored in the electronic device 101, when the state of the electronic device 101 matches a specific state (for example, a state in which a web browser is terminated, a state in which the electronic device 101 is rebooted or the electronic device 101 is powered off), the electronic device 101 may discard (or delete) the information regarding the plurality of webs stored in the electronic device 101, in response to the state of the electronic device 101 matching the specific state. However, a method for processing the information regarding the plurality of webs stored in the electronic device 101 is not limited thereto.

In some example embodiments, the electronic device 101 may classify the information regarding the plurality of webs according to types of services provided by the webs. In one example embodiment, the electronic device 101 may store information regarding a web providing a transaction-related service from among the plurality of webs while distinguishing it from information regarding webs providing other services. For example, the electronic device 101 may pre-store information regarding address of webs providing a transaction-related service in the electronic device 101. In this case, the electronic device 101 may compare an address of a web that the electronic device 101 accesses with the pre-stored information. When the pre-stored information includes the address of the web that the electronic device 101 accesses, the electronic device 101 may store the information regarding the web that the electronic device 101 accesses while distinguishing it from information regarding the other webs providing services unrelated to the transaction. However, a method for storing the information regarding the web that the electronic device 101 accesses is not limited thereto.

In operation 720, the electronic device 101 (for example, the processor 120) may receive a message for indicating that the transaction is completed from another entity such as the payment server 520, etc. In other words, the electronic device 101 may receive information regarding payment from another entity. The information regarding the payment may include data regarding a name of the item traded via the electronic device 101, data regarding a price of the item, data for identifying a source selling the item, data regarding a date at which the transaction is completed, data for identifying a means used for the payment, data regarding the total amount of money paid by the means for paying during a configured period, etc.

In operation 730, the electronic device 101 (for example, the processor 120, etc.) may determine information regarding the item of the transaction, based on information regarding candidate webs that the electronic device 101 has accessed during an interval which is determined based on a timing at which the message is received. An end point of the interval may be immediately before or after the timing at which the message is received, and a start point of the interval may be a point specific time before the end point of the interval. Herein, the specific time may be a length of the interval.

In some example embodiments, the length of the interval may have a different value according to setting. In one example embodiment, the length of the interval may be determined according to setting of the user. For example, when the user of the electronic device 101 sets the length of the interval to be from a timing 10 minutes before the timing when the message is received to the timing at which the message is received, the electronic device 101 may refer to information regarding candidate webs that the electronic device 101 accesses from the timing 10 minutes before the timing at which the message is received to the timing at which the message is received, from the information regarding the plurality of webs stored in operation 710, based on the message being received. The electronic device 101 may determine information regarding the item of the transaction based on the referred information regarding the candidate webs. In another example embodiment, the length of the interval may be determined based on statistical data which is learned by the electronic device 101. For example, when the user of the electronic device 101 normally completes the transaction through the accessed web within 15 minutes from the timing when the user accesses the web associated with the transaction, the electronic device 101 may learn a pattern in which the user of the electronic device 101 uses the web associated with the transaction. The electronic device 101 may configure the length of the interval based on the learned statistical data. However, a method for the electronic device 101 to determine the length of the interval is not limited thereto.

The candidate webs may be set differently according to setting of the electronic device 101 or an operation method. In some example embodiments, the candidate webs may be webs that the electronic device 101 has accessed during the interval from among the plurality of webs that the electronic device 101 has accessed. In some example embodiments, the candidate webs may be webs that the electronic device 101 has accessed during the interval from among the webs associated the transaction and stored while being distinguished from the other webs, from among the plurality of webs that the electronic device 101 has accessed. In other words, the electronic device 101 may refer to only the webs that the electronic device 10 has accessed during the interval from among the webs associated with the transaction and accessed by the electronic device 101, rather than referring to all webs included in the information stored in the electronic device 101.

The electronic device 101 may determine the information regarding the item of the transaction based on data regarding a domain name of at least one of the candidate webs included in the referred information of the candidate webs, or data regarding web documents of at least one of the candidate webs.

The domain name may be information for complementing low accessibility of an internet protocol (IP) address which is accessible by the electronic device 101 and by which various servers providing web services are classified. In other words, the domain name may be data having a value corresponding to a unique address (for example, an IP address, etc.) of each of the servers. The domain name may be set by a word having a meaning or a combination of words. Since the domain name is set by a word having a meaning or a combination of words, a user using the domain name may access the Internet more easily and intuitively using the domain name. The domain name may be referred to as a fully qualified domain name (FQDN).

The web document may be a document which is used for a web (e.g., webpage and/or website) that the electronic device 101 accesses. For example, the electronic device 101 may display information or data regarding a web that the electronic device 101 accesses on the display 160 based at least partly on data included in the web document. In another example, the electronic device 101 may grasp what various contents included in the web are, based on the web document. For example, the electronic device 101 may grasp what characters written on the displayed web are, what an image attached to the displayed web is, what a moving image displayed on the displayed web is, what else is associated with the displayed web, etc. The web document may be a hypertext markup language (HTML) document or a cascading style sheets (CSS) document. The web document may have a document object model (DOM) tree format.

The electronic device 101 may determine at least one web associated with the transaction from among the candidate webs, by comparing the addresses of the candidate webs and addresses of webs associated with the transaction, which are pre-stored in the electronic device 101. In addition, the electronic device 101 may specify what the item of the transaction associated with the received message is by analyzing (or parsing) the data included in the web document of the determined at least one web.

In the above description of FIG. 7, the operations shown in FIG. 7 are performed by the electronic device 101, but this is merely an example for convenience of explanation. Some of the operations shown in FIG. 7 may be performed by another entity such as the big data server 510. In this case, the electronic device 101 may provide a criterion or information for performing at least a portion of the operations to the big data server 510.

As described above, the electronic device 101 according to various example embodiments may specify the item of the completed transaction, based on the message indicating that the transaction is completed being received. The electronic device 101 may process only the candidate webs that the electronic device 101 has accessed during the interval, determined based on the timing when the message is received, rather than processing all webs that the electronic device 101 has accessed in order to specify the item of the transaction, and thereby reduce a load amount of the electronic device 101.

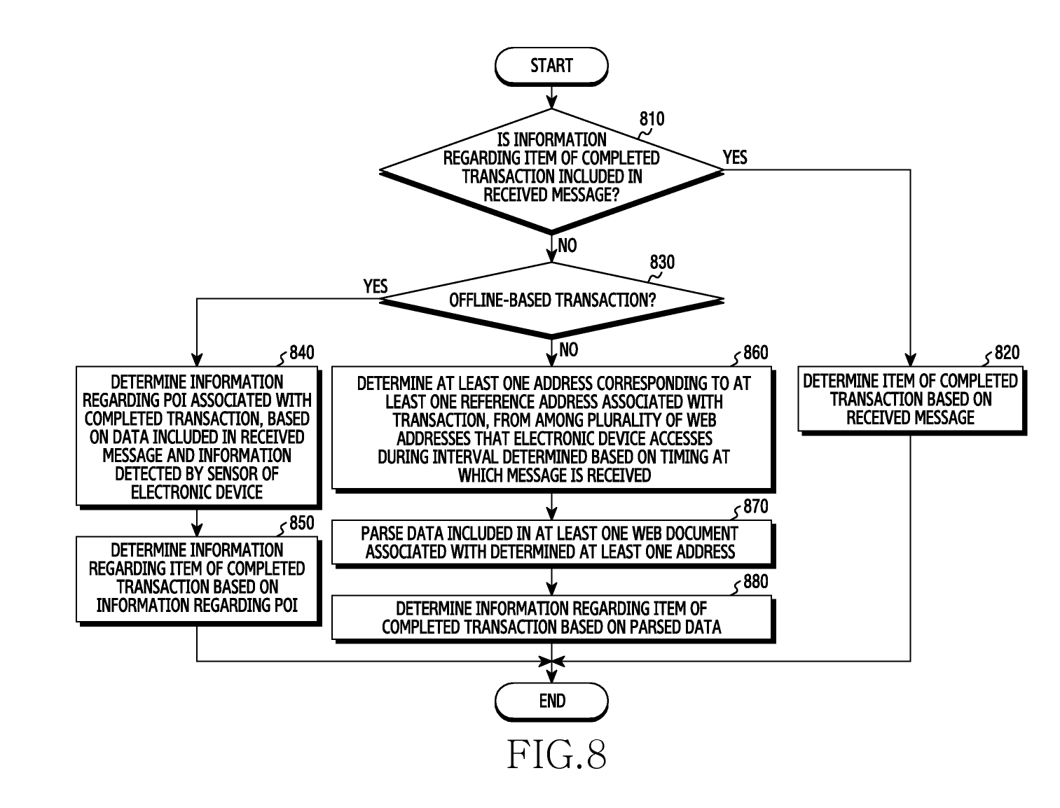

FIG. 8 is a view showing an example of another operation of the electronic device determining information regarding an item based on web information according to various example embodiments. This operation may be performed by the electronic device 101 shown in FIG. 1 or an element of the electronic device 101 such as the processor 120, etc.

Referring to FIG. 8, in operation 810, the electronic device 101 (e.g., the processor 120, etc.) may determine or identify whether information regarding an item of a completed transaction is included in a received message. The message may be a message which is received at the electronic device 101 from the payment server 520, etc. The message may include information for indicating that the transaction associated with the electronic device 101 is completed.

In some example embodiments, the electronic device 101 may parse data included in the message. The electronic device 101 may identify whether it is possible to specify the item of the transaction associated with the electronic device 101 based on the parsed data. For example, when information for identifying the item is included in the parsed data, the electronic device 101 may determine the item based on the parsed data. On the other hand, when the information for identifying the item is not included in the parsed data, the electronic device 101 may perform other operations for determining the item. In other words, when information regarding the item of the completed transaction is included in the received message, the electronic device 101 may perform operation 820. On the other hand, when the information regarding the item of the completed transaction is not included in the received message, the electronic device 101 may perform operation 830.

When the information regarding the item of the completed transaction is included in the received message, the electronic device 101 (for example, the processor 120, etc.) may determine the item of the completed transaction based on the received message in operation 820. The electronic device 101 may parse data included in the message. In some example embodiments, the electronic device 101 may determine the item of the completed transaction using only the parsed data. In some example embodiments, the electronic device 101 may access a web which is derived based on the parsed data or may access the big data server 510 in order to complement the information regarding the item of the transaction which is determined using only the parsed data. In this case, the electronic device 101 may determine the item of the completed transaction by combining at least partly data included in the accessed web, data included in the big data server 510, or the parsed data. However, a method of the electronic device 101 is not limited thereto.

When the information regarding the item of the completed transaction is not included in the received message, the electronic device 101 (for example, the processor 120, etc.) may identify or determine whether the completed transaction is an offline-based transaction in operation 830. In some example embodiments, the electronic device 101 may identify whether the completed transaction is an offline-based transaction based on the data parsed in operation 810. For example, the electronic device 101 may identify whether the completed transaction is an offline-based transaction or an online-based transaction, based on source information (for example, XX restaurant, YY online mart, etc.) regarding the item of the transaction, which is included in the parsed data. In another example, the electronic device 101 may identify whether the completed transaction is an offline-based transaction or an online-based transaction, based on at least one of the parsed data, learning data which is obtained by the big data server 510 or the POI server, or data learned by the electronic device 101. When the completed transaction is the offline-based transaction, the electronic device 101 may perform operation 840. On the other hand, when the completed transaction is the online-based transaction, the electronic device 101 may perform operation 860.

When the completed transaction is the offline-based transaction, the electronic device 101 (for example, the processor 120, etc.) may determine information regarding POI associated with the completed transaction based on the data included in the received message and information detected by the sensor of the electronic device 101 in operation 840.

In some example embodiments, the electronic device 101 may determine brief information regarding the item of the completed transaction using the data which is parsed in operation 810. For example, the electronic device 101 may specify that “the price of the item of the transaction is 10,000 won” and “the transaction place of the item is a Y coffee shop in Gangnam-gu” using the parsed data.

In some example embodiments, the electronic device 101 may determine sensing information using the sensor of the electronic device 101 or the wireless communication interface of the electronic device 101. For example, the sensing information may be coordinate data of a point at which the electronic device 101 is positioned, which is obtained by a GPS of the electronic device 101. In another example, the sensing information may be data which is included in a signal received via the wireless communication interface of the electronic device 101. The data included in the sensing information may be data regarding a medium access control (MAC) address of another electronic device (for example, a base station, an AP, a Bluetooth signal transmitting apparatus, etc.), which is included in the received signal, or data for identifying another electronic device (for example, an identifier (ID) of another electronic device, etc.). The electronic device 101 may specify information regarding the completed transaction based on the sensing information. For example, the electronic device 101 may transmit the sensing information to a POI server associated with the electronic device 101. In addition, the electronic device 101 may request POI information associated with the sensing information. The POI server may determine POI information associated with the sensing information using data stored in the POI server, and may transmit the determined POI information to the electronic device 101. For example, the POI server may compare data of the MAC address included in the sensing information and information stored in the POI server. The POI server may determine that the place where the electronic device 101 is positioned is the “second Y coffee shop in Gangnam-gu” based on the comparison. The POI server may transmit data for indicating that the place where the electronic device 101 is positioned is the “second Y coffee shop in Gangnam-gu” to the electronic device 101. However, a method of the electronic device 101 is not limited thereto.

The electronic device 101 may determine information regarding POI associated with the completed transaction based at least partly on the parsed data, the data received from the POI server, or a combination thereof.

In operation 850, the electronic device 101 (for example, the processor 120, etc.) may determine information regarding the item of the completed transaction based on the information regarding the POI. In the above-described example, the electronic device 101 may grasp that the completed transaction is the “second Y coffee shop in Gangnam-gu” and “the price of the item of the transaction is 10,000 won,” by analyzing the information regarding the POI. The electronic device 101 may determine that the item of the completed transaction is “Irish coffee” which is a unique item that is sold at the second Y coffee shop in Gangnam-gu and has the price of 10,000 won, based on the grasped information. In addition, the electronic device 101 may determine that the item of the completed transaction is “green tea Frappuccino” or “white chocolate mocha” which is an item that is sold at the second Y coffee shop in Gangnam-gu and has the price of 10,000 won, based on the grasped information. In this case, the electronic device 101 may display a message for asking which one of “green tea Frappuccino” or “white chocolate mocha” is the item of the completed transaction on the display 160. The electronic device 101 may determine that the item of the transaction is “green tea Frappuccino” in response to a user's input for selecting “green tea Frappuccino” from “green tea Frappuccino” and “white chocolate mocha” being detected.

In other words, even when the completed transaction is the offline-based transaction, the electronic device 101 may determine the item of the completed transaction using at least one of the message received from the payment server, etc., the information collected by the electronic device 101, or the information received from the POI server.

When the completed transaction is not the offline-based transaction, in operation 860, the electronic device 101 (for example, the processor 120, etc.) may determine at least one address corresponding to at least one reference address associated with the transaction from among addresses of a plurality of webs that the electronic device 101 has accessed during an interval which is determined based on a timing at which the message is received.

The reference address may be an address which is pre-stored in the electronic device 101. The reference address may be used to identify a web address associated with the transaction from among the plurality of web addresses. For example, the reference address may be “www.gomarket.com,” “www.aemegon.com,” “www.taubau.com,” “www.alibabo.com,” etc. The reference address may be stored in the electronic device 101 in the process of releasing the electronic device 101 or updating the electronic device 101, may be received from the big data server 510 and stored, or may be stored by learning by the electronic device 101. For example, addresses of famous shopping malls which are well known to many users may be stored in the electronic device 101 as the reference address in the process of releasing or updating the electronic device 101. In another example, address of shopping malls which are not famous and not well known to many users may be stored in the electronic device 101 as the reference address through learning by the electronic device 101, or may be stored in the electronic device 101 as the reference address through learning by the big data server 510. However, a method for storing or determining the reference address is not limited thereto.

The electronic device 101 may select addresses of webs that the electronic device 101 has accessed during the interval from among the address of the plurality of webs that the electronic device 101 has accessed, and may determine an address of at least one web associated with the transaction by comparing the selected addresses of the webs and the at least one reference address. For example, the electronic device 101 may select addresses of webs A(1), A(k−1), A(k), A(k+1), A(n−1), A(n) that the electronic device 101 has accessed during the interval from among the addresses of the plurality of webs A(1), A(k), A(n) that the electronic device 101 has accessed, and may compare the selected addresses A(1), A(k−1), A(k), A(k+1), A(n−1), A(n) and reference addresses B(1), B(2), B(3), B(4) stored in the electronic device 101. The electronic device 101 may determine that addresses A(k−1), A(k), A(k+1) correspond to at least one of the reference addresses B(1), B(2), B(3), B(4), and addresses A(1), A(n−1), A(n) do not correspond to all of the reference addresses B(1), B(2), B(3), B(4). In other words, the electronic device 101 may determine addresses A(k−1), A(k), A(k+1) as addresses associated with the transaction.

In operation 870, the electronic device 101 (for example, the processor 120, etc.) may parse data included in at least one web document associated with the determined at least one address.

In some example embodiments, the web document may have a DOM tree format. The electronic device 101 may parse the data included in the at least one web document using a rule-based parsing method (a method using a parser tool, a library, etc.) or a machine learning-based method.

The parsed data may include a common tag.

In some example embodiments, the electronic device 101 may further filter the determined at least one address prior to referring to the at least one web document associated with the determined at least one address. For example, the electronic device 101 may classify the determined at least one address into a plurality of actions or paths by parsing the determined at least one address (for example, URL). For example, the electronic device 101 may classify the determined at least one address into an address of an item search action, an address of an item detailed information displaying action, or an address of an item buying action. In the above-described example, the electronic device 101 may classify the address A(k−1) from among the determined at least one address A(k−1), A(k), A(k+1) as the address of the item search action, the address A(k) as the address of the item detailed information displaying action, and the address A(k+1) as the address of the item buying action. In this case, the electronic device 101 may refer to only the web document associated with the addresses A(k) and A(k+1) which have a high probability that they include relatively much data for specifying the item of the completed transaction, and may parse only the data included in the referred web document.

In operation 880, the electronic device 101 (for example, the processor 120, etc.) may determine information regarding the item of the completed transaction based on the parsed data. For example, the electronic device 101 may extract a common tag from the parsed data. The common tag may include data regarding an image of the completed transaction, data regarding a source of the completed transaction, data regarding a price of the item of the completed transaction, data regarding a name, a trademark, a brand, a volume, etc. of the item of the completed transaction. However, the data included in the common tag is not limited thereto. The electronic device 101 may determine the information regarding the item of the completed transaction by comparing the data included in the common tag and data included in the received message.

In some example embodiments, the electronic device 101 may further process the determined information regarding the item of the transaction although it is not illustrated in FIG. 8. For example, the electronic device 101 may process the determined information regarding the item of the transaction to arrange and store an image of the item, a price of the item, a source of the item, a promotion period of the item, etc., or to transmit the same to another entity.

In the description of FIG. 8, the operations shown in FIG. 8 are performed by the electronic device 101, but this is merely an example for convenience of explanation. At least some of the operations shown in FIG. 8 may be performed by another entity such as the big data server 510. In this case, the electronic device 101 may provide a criterion or information for performing at least some of the operations to the big data server 510.

As described above, the electronic device 101 according to various example embodiments may determine the item of the completed transaction based on at least one of the received message, the POI data, or the parsing data regarding the web document. In addition, the electronic device 101 may determine the item of the completed transaction based on at least one of the received message, the POI data, or the parsing data regarding the web document, such that it can determine the item of the completed transaction regardless of whether the type of the completed transaction is the offline-based transaction or the online-based transaction.

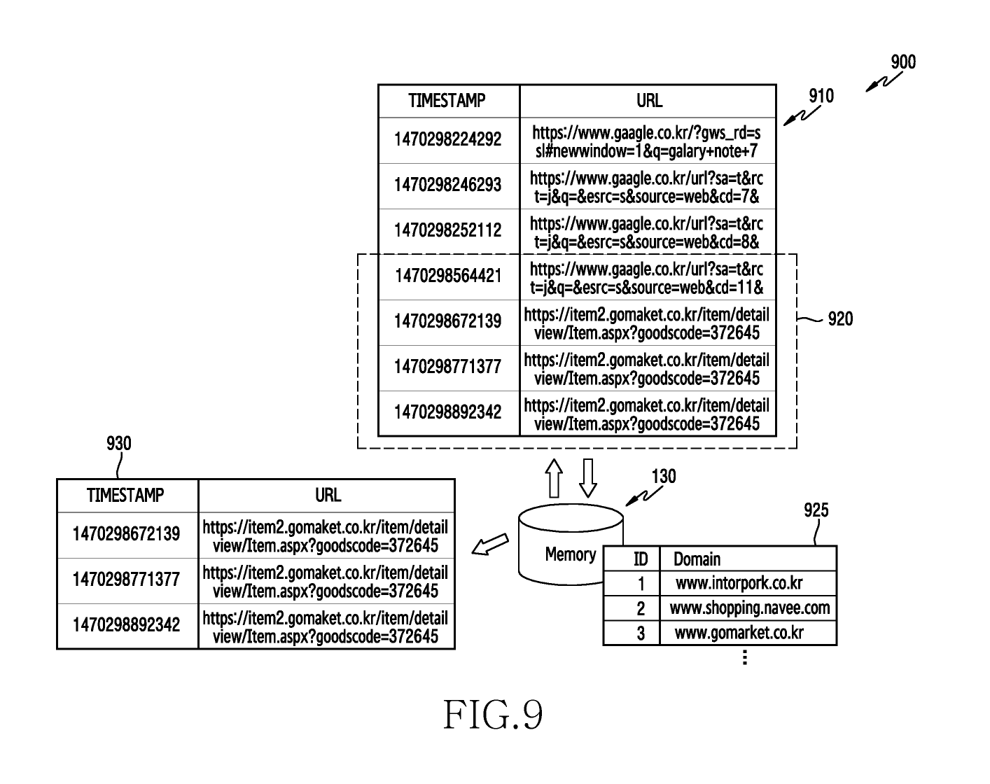

FIG. 9 is a concept view to illustrate a method for determining a web address associated with a transaction from among a plurality of web addresses according to various example embodiments.

Referring to FIG. 9, the concept view 900 may include data 910 indicating addresses of a plurality of webs that the electronic device 101 accesses immediately before or after receiving a message indicating that a transaction is completed from the payment server 520, data 925 regarding reference addresses which are pre-stored in the electronic device 101, and/or data 930 regarding addresses associated with the transaction determined by the electronic device 101. The data 910, the data 925, and the data 930 may be data which is stored (or temporarily stored) in the memory 130 of the electronic device 101.

The data 910 may be classified based on “TIME STAMP” for indicating a timing at which the electronic device 101 accesses a web page, and “URL” for indicating an address of the web page. The electronic device 101 may distinguish data a predetermined time before the timing at the message is received from the payment server 520, etc. (that is, URLs of web pages that the electronic device 101 has accessed during an interval determined based on the timing at which the message is received) from the data 910. For example, the electronic device 101 may determine URLs having TIME STAMP “1470298564421,” “1470298672139,” “1470298771377,” and “1470298892342,” included in the data 920, as URLs of web pages that the electronic device 101 has accessed during the interval determined based on the timing at which the message is received.

The electronic device 101 may compare the data 920 and the data 925. For example, the electronic device 101 may determine URLs except for the URL having TIME STAMP “1470298564421” of the data 920 which is not included in the data 925, as web addresses associated with the transaction. In other words, the electronic device 101 may determine the data 930 which includes the same URL as the URL associated with “gomarket” corresponding to ID 3 included in the data 925, as a URL associated with the transaction.

As described above, the electronic device 101 according to various example embodiments may extract the address of the web page associated with the transaction by filtering the plurality of web addresses that the electronic device 101 has accessed based on the reference addresses and the timing at which the message is received.

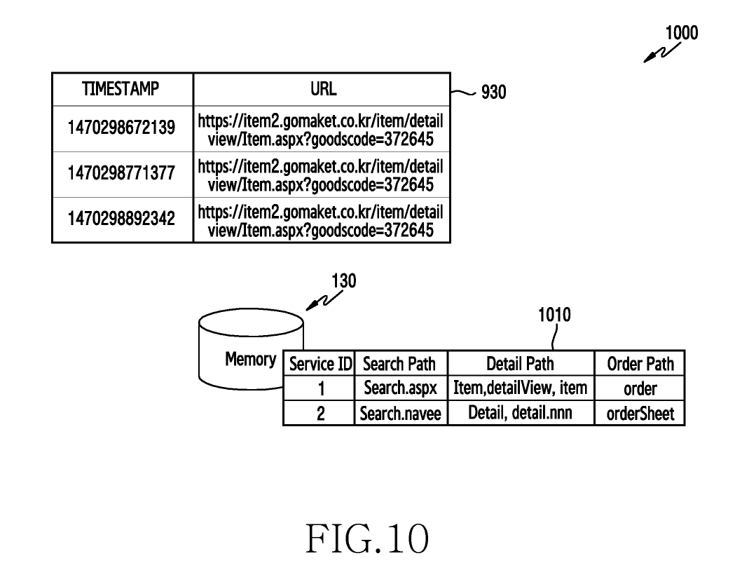

FIG. 10 is a concept view to illustrate a method for classifying web addresses by actions according to various example embodiments.

Referring to FIG. 10, the concept view 1000 may include data 930 regarding addresses of web pages associated with a transaction, and reference data 1010 for classifying actions (or paths) indicated by web addresses. The data 930 and the reference data 1010 may be stored in the memory 130 of the electronic device 101.

The data 930 shown in FIG. 10 may correspond to the data 930 shown in FIG. 9. In addition, the data 1010 may be data which is determined in operation 860 of FIG. 8.

The reference data 1010 may be classified by an ID for identifying a service type, a search path, a detail path (path for providing detailed information of an item), a buying path (or an order path), and may be stored.

The electronic device 101 may determine whether the data 930 includes data included in the reference data 1010 by comparing the data 930 and the reference data 1010. For example, the electronic device 101 may determine that URLs having TIME STAMP values of “1470298672139,” “1470298771377,” and “1470298892342” include “item” and “detailview” which correspond to the detail path of ID 1 of the data 1010. The electronic device 101 may determine the URLs included in the data 930 as the addresses of the web pages associated with the transaction based on the determination.

As described above, the electronic device 101 according to various example embodiments may filter the filtered web pages once more according to a path in order to simplify the operation of parsing data included in a web document.

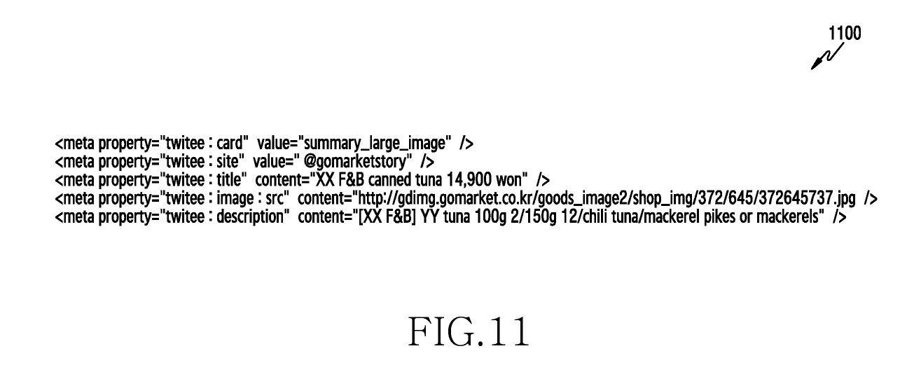

FIG. 11 is a concept view to illustrate an example of a common tag included in parsed data according to various example embodiments.

Referring to FIG. 11, the electronic device 101 may extract a common tag like data 1100 by parsing, as in operation 860 of FIG. 8, data included in at least one web document associated with at least one web address which is determined in operation 860, etc. of FIG. 8. For example, the data 1100 may be a common tag that is extracted by parsing a web document associated with one URL from among the URLs included in the data 930 shown in FIG. 10.

The electronic device 101 may analyze the data 1100. For example, the electronic device 101 may obtain a variety of information from the data 1100 by parsing the data 1100. For example, the electronic device 101 may determine that the type of the item of the completed transaction is “canned tuna,” a producer of the item of the transaction is “XX,” a seller of the item of the transaction is “F&B,” a price of the item of the transaction is “14,900 won,” based on information “content=“XX F&B canned tuna 14,900 won” in the data 100. In addition, the electronic device 101 may identify that a name of the item of the completed transaction is “YY tuna,” a volume of one item of the completed transaction is “100 g” and a pack of 12 cans,” the type of the time is “chili tuna,” and an item sold with the item is “mackerel pikes or mackerels” based on information “content=“[XX F&B] YY tuna 100 g×2/150 g×12/chili tuna/mackerel pikes or mackerels.”

The electronic device 101 may determine the information regarding the item of the completed transaction by combining the determined information and adding, to the information regarding the item of the completed transaction, information that “the producer of the item is XX,” “the seller of the item is F&B,” “the type of the item is YY chili tuna and mackerel pikes and mackerels,” “the price of the item is 14,900 won,” and “the amounts of items for selling are 100 g×12 of chili tuna, 150 g×12 of mackerel pikes or mackerels.”

Furthermore, the electronic device 101 may transmit the determined information regarding the item of the transaction to another entity, and may display the determined information regarding the item of the transaction on the display 160 of the electronic device 101.

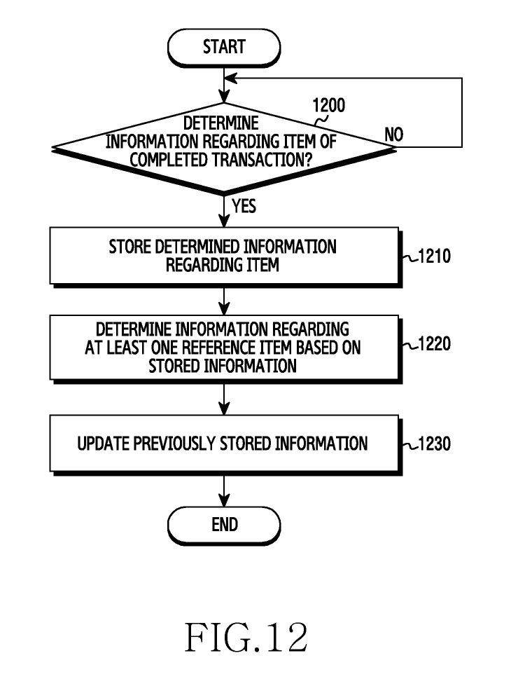

FIG. 12 is a view showing an example of an operation of an electronic device determining information regarding a reference item according to various example embodiments. This operation may be performed by the electronic device 101 shown in FIG. 1 or an element of the electronic device 101 such as the processor 120, etc.

Referring to FIG. 12, in operation 1200, the electronic device 101 (for example, the processor 120, etc.) may determine whether information regarding an item of a completed transaction is determined. The electronic device 101 may determine whether the information regarding the item of the completed transaction is determined in order to update information regarding a reference item (or a preferred item) which is stored in the electronic device 101. In some example embodiments, the reference item may indicate a preferred item of the user of the electronic device 101. In some example embodiments, the reference item (or preferred item) may be one independent item (for example, specific product information). In some example embodiments, the reference item (or preferred item) may be a product category including the item of the completed transaction. For example, when the item of the completed transaction is “sneakers by XX brand,” the reference item may indicate at least one of shoes, XX brand, or sneakers.

When the information regarding the item of the completed transaction is determined, the electronic device 101 may perform operation 1210. On the other hand, when the information regarding the item of the completed transaction is not determined, the electronic device 101 may repeatedly perform operation 1200. In other words, when the information regarding the item of the completed transaction is not determined, the electronic device 101 may continuously monitor whether the information regarding the item of the completed transaction is determined.

In response to the information regarding the item of the completed transaction being determined, the electronic device 101 (for example, the processor 120, etc.) may store (or temporarily store) the determined information regarding the item in operation 1210. The electronic device 101 may store the determined information regarding the item in order to update the information regarding the reference item which is stored in the electronic device 101.

In operation 1220, the electronic device 101 (for example, the processor 120, etc.) may determine information regarding at least one reference item based on the information regarding the reference item which is stored in the electronic device 101, and the information regarding the item which is stored in operation 1210. In other words, the electronic device 101 may determine the information regarding the at least one reference item by combining accumulated data which is stored in the electronic device 101 and data which is newly generated at the electronic device 101.

In operation 1230, the electronic device 101 (for example, the processor 120, etc.) may update the information regarding the reference item which is previously stored based on the determined information regarding the at least one reference item. For example, the electronic device 101 may update the information regarding the reference item by adding a reference item D determined through operation 1220 to reference items A, B, C which are previously stored. In another example, the electronic device 101 may update the information regarding the reference item by discarding (or deleting) the reference item B from the reference items A, B, C which are previously stored, and adding the reference item D determined through operation 1220.

As described above, the electronic device 101 according to various example embodiments may determine and update the reference item in order to reflect preference of the user of the electronic device 101. In addition, the electronic device 101 may determine and update the reference item in order to determine whether to display a notification message received from another entity such as the big data server 510, etc.

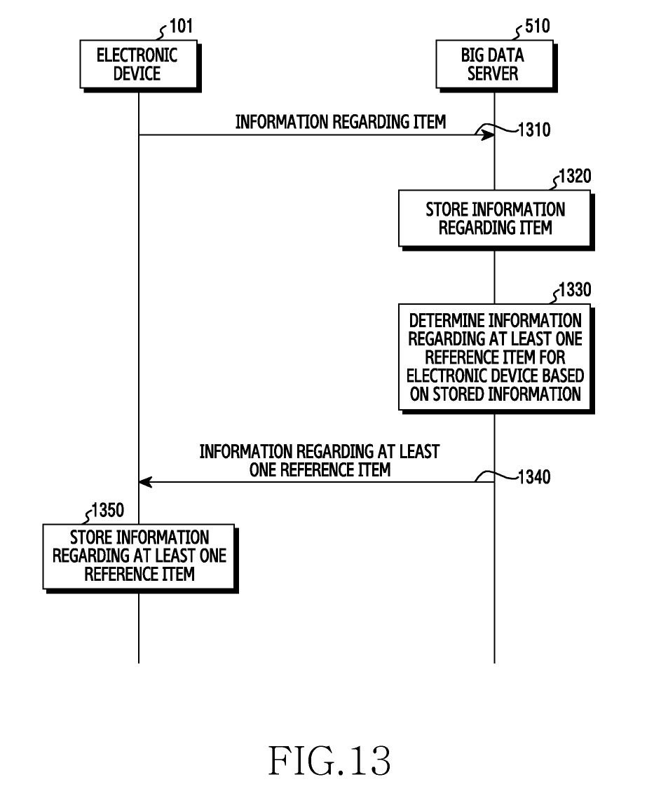

FIG. 13 is a view showing an example of a signal flow between a big data server determining information regarding a reference item, and an electronic device according to various example embodiments. This signal flow may be caused by the electronic device 101 shown in FIG. 1, an element of the electronic device 101 such as the processor 120, etc., the big data server 510 shown in FIG. 5, or an element of the big data server 510.

Referring to FIG. 13, in operation 1310, the electronic device 101 (for example, the processor 120, etc.) may transmit information regarding an item of a completed transaction to the big data server 510. In some example embodiments, the information regarding the item may be transmitted to the big data server 510 every time the electronic device 101 determines information regarding the item of the completed transaction. In some example embodiments, the information regarding the item may be transmitted to the big data server 510 in every period which is determined by the electronic device 101, the big data server 510, or negotiation between the electronic device 101 and the big data server 510. When the information regarding the item is not determined by the electronic device 101 during the determined period, the electronic device 101 may not transmit the information regarding the item or may include data indicating a NULL value in the information regarding the item and transmit the information regarding the item. In some example embodiments, the information regarding the item may be transmitted to the big data server 510 based on an operation state of the electronic device 101 reaching a specific state. For example, when a load amount of the electronic device 101 is less than a threshold value, the electronic device 101 may transmit the information regarding the item to the big data server 510. However, a condition for transmitting the information regarding the item is not limited thereto. The big data server 510 may receive the information regarding the item from the electronic device 101.

In operation 1320, the big data server 510 (for example, a processor, etc. in the big data server 510) may store in memory the received information regarding the item. The big data server 510 may store the received information regarding the item in order to grasp preference(s) of the user of the electronic device 101, or in order to determine information regarding reference data for the electronic device 101.

In operation 1330, the big data server 510 (for example, a processor, etc. in the big data server 510) may determine information regarding at least one reference item for the electronic device 101 based on the stored information. When there is information regarding a reference item that is previously stored in the big data server 510 for the electronic device 101, the big data server 510 may determine at least one reference item for the electronic device 101 based on the information regarding the reference item which is previously stored, and the stored information regarding the item. In other words, the big data server 510 may determine at least one reference data for the electronic device 101 based on the existing information stored in the big data server 510 and information which is newly inputted to the big data server 510.

In operation 1340, the big data server 510 (for example, a processor, etc. in the big data server 510) may transmit or cause to be transmitted the determined information regarding the at least one reference item to the electronic device 101. In some example embodiments, the information regarding the at least one reference item may be transmitted from the big data server 510 to the electronic device 101 every time the information regarding the at least one reference item is updated. In some example embodiments, the information regarding the at least one reference item may be transmitted from the big data server 510 to the electronic device 101 in every period which is determined by the electronic device 101, the big data server 510, or negotiation between the electronic device 101 and the big data server 510. In some example embodiments, the information regarding the at least one reference item may be transmitted according to a time band. For example, the big data server 510 may transmit the information regarding the at least one reference item at dawn when the load amount of the electronic device 100 is relatively low. However, a condition for transmitting the information regarding the at least one reference item is not limited thereto.

The electronic device 101 (for example, the processor 120, etc.) may receive the information regarding the at least one reference item from the big data server 510.

According to example embodiments, operation 1330 and/or operation 1340 may be omitted. For example, it should be noted that, when a notification message transmitted from the big data server 510 is transmitted in a unicast method, the big data server 510 may optionally not perform operation 1330 and/or operation 1340.

In operation 1350, the electronic device 101 (for example, the processor 120, etc.) may store (or temporarily store) the received information regarding the at least one reference item in the memory 130, etc. of the electronic device 101. The stored information regarding the at least one reference item may be used as a criterion for determining whether to display the notification message.

As described above, the big data server 510 according to various example embodiments may determine the information regarding the reference item for the electronic device 101. Through this operation, the big data server 510 may grasp characteristics or preference of the user of the electronic device 101 without being limited to a specific shopping mall.

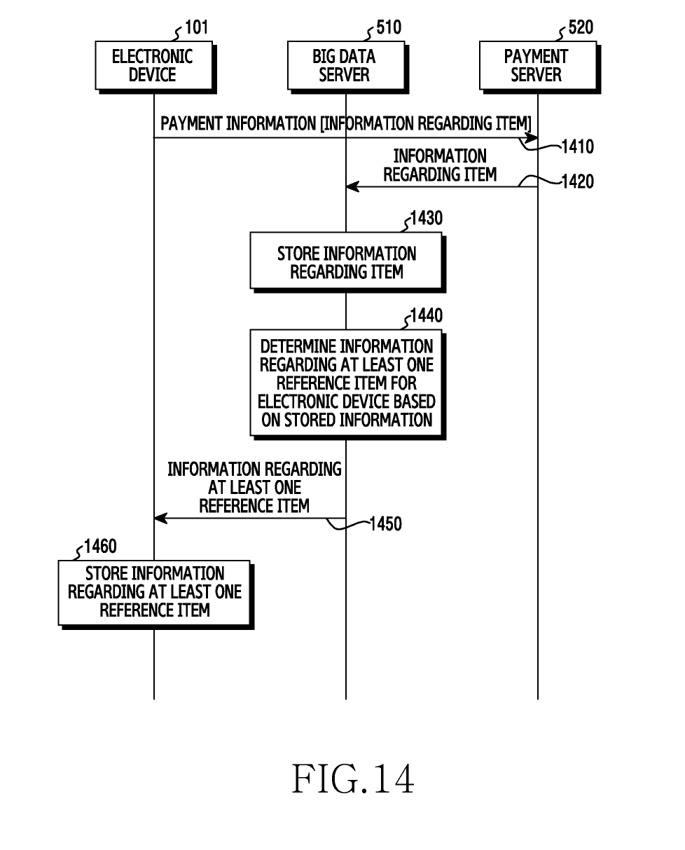

FIG. 14 is a view showing an example of a signal flow among a big data server determining information regarding a reference item, a payment server, and an electronic device according to various example embodiments. This signal flow may be caused by the electronic device 101 shown in FIG. 1, an element of the electronic device 101 such as the processor 120, etc., the payment server 520 shown in FIG. 5, an element of the payment server 520, the big data server 510 shown in FIG. 5, or an element of the big data server 510.

Referring to FIG. 14, in operation 1410, the electronic device 101 (for example, the processor 120, etc.) may transmit or cause to be transmitted payment information including information regarding an item to the payment server 520. In other words, the electronic device 101 may transmit a message for completing a transaction, which includes the information regarding the item, to the payment server 520. The payment information may be transmitted via an application for a mobile payment service which is stored in the electronic device 101. For example, the payment information may be transmitted via a mobile payment application stored in the electronic device 101.

The payment server 520 (for example, a processor, etc. in the payment server 520) may receive the payment information including the information regarding the item from the electronic device 101.

Operation 1410 exemplifies signaling in which the information regarding the item is included in the payment information and is transmitted, but this is merely an example for convenience of explanation. The information regarding the item may be transmitted through a separate transmitting procedure different from the transmitting procedure of the payment information.

In operation 1420, the payment server 520 (for example, a processor, etc. in the payment server 520) may provide the received information regarding the item to the big data server 510. In other words, the payment server 520 may transmit the received information regarding the item to the big data server 510. In some example embodiments, the payment server 520 may further process the received information regarding the item and may transmit the information to the big data server 510. The big data server 510 may receive the information regarding the item from the payment server 520.

Operations 1430 to 1460 may correspond to operations 1320 to 1350 shown in FIG. 13.

As described above, when the electronic device 101 according to various example embodiments executes a transaction using an application for a mobile payment service, the big data server 510 according to various example embodiments may determine information regarding a reference item for the electronic device 101 by receiving the information regarding the item of the transaction via the payment server 520, etc. Through this operation, the big data server 510 may grasp characteristics or preference of the user of the electronic device 101 without being limited to a specific shopping mall.

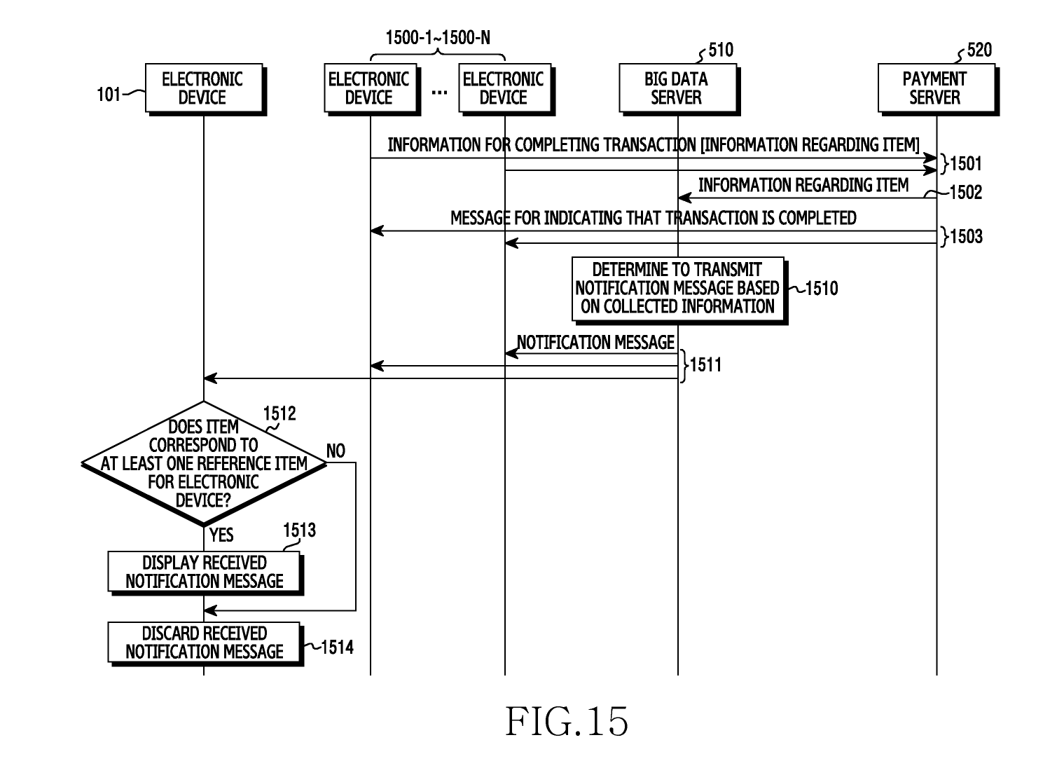

FIG. 15 is a view showing an example of a signal flow among an electronic device receiving a notification message, a big data server, and a payment server according to various example embodiments. This signal flow may be caused by the electronic device 101 shown in FIG. 1, an element of the electronic device 101 such as the processor 120, etc., the payment server 520 shown in FIG. 5, an element of the payment server 520, the big data server 510 shown in FIG. 5, or an element of the big data server 510.

Referring to FIG. 15, in operation 1501, each of electronic devices 1500-1 to 1500-N (for example, a processor, etc. in each of the electronic devices 1500-1 to 1500-N) may transmit information for completing a transaction(s), which includes information regarding an item that the user of each of the electronic devices 1500-1 to 1500-N wishes to buy, to the payment server 520. In other words, each of the electronic devices 1500-1 to 1500-N may transmit payment information including the information regarding the item, which is determined in operation 610, etc., to the payment server 520. The payment server 520 may receive the payment information including the information regarding the item from each of the electronic devices 1500-1 to 1500-N.

In operation 1502, the payment server 520 (for example, a processor, etc. in the payment server 520) may provide the received information regarding the item to the big data server 510. The big data server 510 may receive the information regarding the item from the payment server 520.

In operation 1503, the payment server 520 (for example, a processor, etc. in the payment server 520) may transmit a message for indicating that the transaction is completed to each of the electronic devices 1500-1 to 1500-N. In other words, the payment server 520 may transmit information regarding the transaction to each of the electronic devices 1500-1 to 1500-N. Each of the electronic devices 1500-1 to 1500-N may receive the information regarding the transaction (or the message for indicating that the transaction is completed) from the payment server 520.

FIG. 15 depicts that operation 1503 is performed after operation 1502, but this is merely for convenience of explanation. According to example embodiments, operations 1502 and 1503 may be performed simultaneously or may be performed regardless of the order.

In operation 1510, the big data server 510 (for example, a processor, etc. in the big data server 510) may determine whether to transmit a notification message based on the information which is collected in operation 1502, etc.

In some example embodiments, the big data server 510 may determine whether to transmit the notification message based on the collected information. In one example embodiment, the big data server 510 may determine that a frequency of a common item appearing in the information received during a predetermined period is greater than or equal to a threshold value. The big data server 510 may determine to transmit the notification message based on the determination. However, a condition for transmitting the notification message in the big data server 510 is not limited thereto. In another example embodiment, the big data server 510 may recognize that a promotion period of an item A is from Jan. 10, 2017 to Jan. 20, 2017 based on the collected information. The big data server 510 may determine to transmit the notification message based on the recognition. However, a condition for transmitting the notification message in the big data server 510 is not limited thereto.

In some example embodiments, the big data server 510 may compare information regarding an item which is newly received and information regarding an item which is previously stored. In addition, the big data server 510 may determine to transmit the notification message based on the result of comparing. For example, the big data server 510 may grasp that the price of the item A is 15,000 won based on the previously stored information, and may grasp that the price of the item A is 9,000 won based on the collected (newly received) information. The big data server 510 may recognize that a difference between the previous price and the current price of the item A is 6,000 won. In addition, the big data server 510 may recognize that the difference in the price is greater than a threshold value of the item A, 5000 won, which is previously stored. In this case, the big data server 510 may determine to transmit the notification message. In another example in the above example, the big data server 510 may recognize that the item is being discounted by 40%. In addition, the big data server 510 may recognize that the discount rate (40%) of the item is greater than a threshold discount rate (30%) of the item. In this case, the big data server 510 may determine to transmit the notification message. However, a condition for transmitting the notification message in the big data server 510 is not limited thereto.

In operation 1511, the big data server 510 (for example, a processor, etc. in the big data server 510) may transmit the notification message to the electronic device 101 and the electronic devices 1500-1 to 1500-N, based on determining to transmit the notification message. In other words, the big data server 510 may broadcast or multicast the notification message. The notification message may include information regarding at least one item which is determined based on the collected information. The electronic device 101 and the electronic devices 1500-1 to 1500-N may receive the notification message from the big data server 510.

In some example embodiments, the big data server 510 may unicast the notification message unlike in operation 1511 of broadcasting the notification message. In this case, the big data server 510 may compare information regarding a reference item of each electronic device which is stored in the big data server 510, and information regarding an item to be included in the notification message. The big data server 510 may determine an electronic device that has a reference item corresponding to the item to be included in the notification message from among the plurality of electronic devices based on the result of comparing. The big data server 510 may unicast the notification message to the determined electronic device.

In operation 1512, the electronic device 101 (for example, the processor 120, etc.) may determine whether the item included in the notification message corresponds to at least one reference item for the electronic device. The at least one reference item may be determined by the method shown in FIG. 12, the method shown in FIG. 13, or the method shown in FIG. 14. The electronic device 101 may determine whether the item included in the notification message corresponds to the at least one reference item for the electronic device in order to determine whether the item included in the notification message is an item associated with the electronic device 101 (or an item suiting preference of the user of the electronic device 101). When the item corresponds to the at least one reference item for the electronic device, the electronic device 101 may perform operation 1513. On the other hand, when the item does not correspond to the at least one reference item for the electronic device, the electronic device 101 may perform operation 1514 and discard the received notification message.

When the item corresponds to the at least one reference item for the electronic device, the electronic device 101 (for example, the processor 120, etc.) may display the notification message in operation 1513. The displayed notification message may include information regarding the item for which an event is generated. The user of the electronic device 101 may recognize what item is on sale, how much the item is reduced by, where the item is sold, how long the promotion period of the item is, how many items are left in stock, etc., through the displayed notification message. According to example embodiments, the electronic device 101 may access a server to buy the item based on an input on an icon or an object included in the displayed notification message being detected. For example, the electronic device 101 may display a web page provided by a seller selling the item on the display 160 of the electronic device 101 based on the input on the object being detected. In another example, the electronic device 101 may execute an application provided by the seller selling the item based on the input on the object being detected, and may display a user interface (UI) for the executed application.

The notification message may attract the attention of the user of the electronic device 101 in various methods. For example, the notification message may be provided in the form of a haptic vibration, a sound, lighting of an indicator, etc. However, a method for providing the notification message is not limited thereto.

When the item does not correspond to the at least one reference item for the electronic device, the electronic device 101 (for example, the processor 120, etc.) may discard the notification message in operation 1514. The item not corresponding to the at least one reference item for the electronic device 101 may indicate that the item has nothing to do with the preference of the user of the electronic device 101. Accordingly, the electronic device 101 may discard the notification message. In some example embodiments, the electronic device 101 may discard the notification message after storing it during a predetermined period unlike in FIG. 15. In addition, in some example embodiments, the electronic device 101 may display the notification message on the display 160 of the electronic device 101 unlike in FIG. 15.

As described above, the big data server 510 according to various example embodiments may monitor the information collected from the plurality of electronic devices, such that it can provide information suiting a current transaction situation of the item to the electronic devices such as the electronic device 101, etc. In other words, the big data server 510 may provide information personalized to a user or a situation to users through the notification message, rather than providing a message having an advertisement.

In addition, the electronic device 101 according to various example embodiments compares the item included in the notification message received from the big data server 510, and the reference item of the electronic device 101, thereby displaying only the information meaningful to the user of the electronic device 101. In other words, the electronic device 101 can provide an improved shopping environment to the user of the electronic device 101.

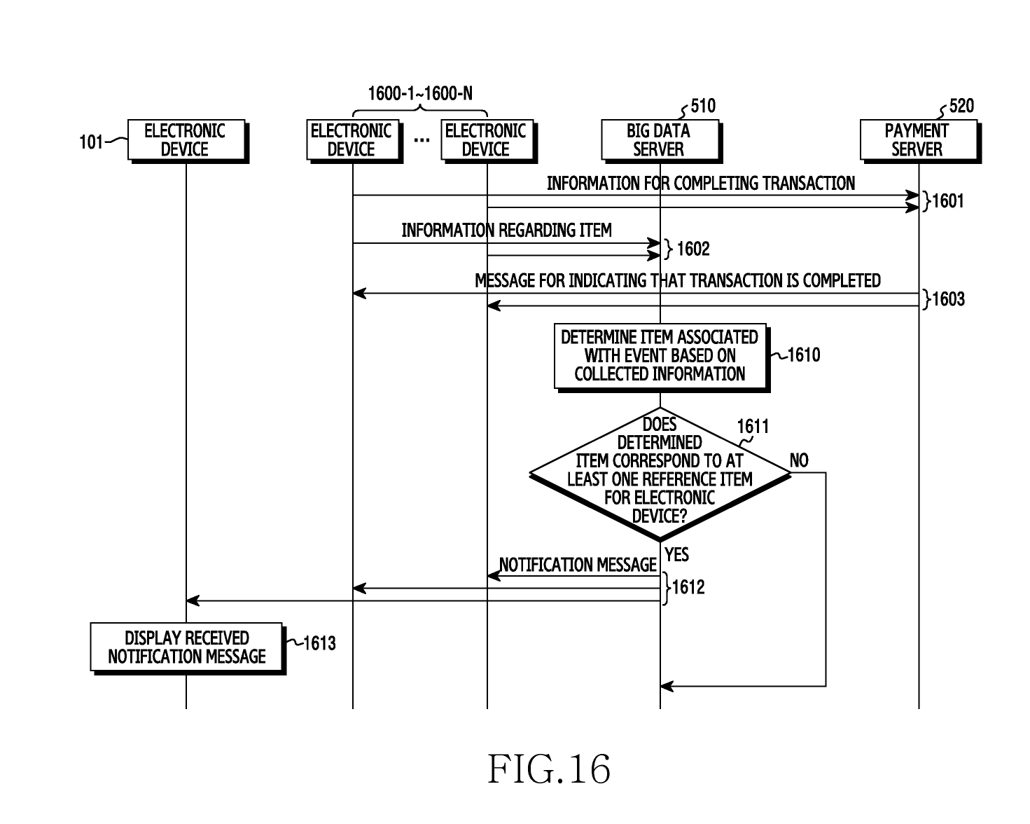

FIG. 16 is a view showing another example of a signal flow among an electronic device receiving a notification message, a big data server, and a payment server according to various example embodiments. This signal flow may be caused by the electronic device 101 shown in FIG. 1, an element of the electronic device 101 such as the processor 120, etc., the payment server 520 shown in FIG. 5, an element of the payment server 520, the big data server 510 shown in FIG. 5, or an element of the big data server 510.

Referring to FIG. 16, in operation 1601, each of electronic devices 1600-1 to 1600-N (for example, a processor, etc. in each of the electronic devices 1600-1 to 1600-N) may transmit, to the payment server 520, information for completing a transaction of an item that the user of each of the electronic devices 1600-1 to 1600-N wishes to buy. In other words, each of the electronic devices 1600-1 to 1600-N may transmit payment information regarding a specific item to the payment server 520. The payment server 520 may receive the payment information from each of the electronic devices 1600-1 to 1600-N.

In operation 1602, each of electronic devices 1600-1 to 1600-N (for example, a processor, etc. in each of the electronic devices 1600-1 to 1600-N) may transmit information regarding an item that the user of each of the electronic device 1600-1 to 1600-N wishes to buy to the big data server 510. In other words, each of the electronic devices 1600-1 to 1600-N may transmit the information regarding the item which is determined in operation 610, etc. to the big data server 510. The big data server 510 may receive the information regarding the item from each of the electronic devices 1600-1 to 1600-N.

FIG. 16 depicts that operation 1602 is performed after operation 1601, but this is merely for convenience of explanation. Operations 1601 and 1602 may be performed simultaneously or may be performed regardless of the order.

In operation 1603, the payment server 520 (for example, a processor, etc. in the payment server 520), which receives the payment information, may transmit a message for indicating that the transaction is completed to each of the electronic devices 1600-1 to 1600-N. In other words, the payment server 520 may transmit information regarding the payment to each of the electronic devices 1600-1 to 1600-N.

In operation 1610, the big data server 510 (for example, a processor, etc. in the big data server 510) may determine an item associated with an event which is determined based on the information collected in operation 1602, etc. For example, in operation 1601, the big data server 510 may perform an operation corresponding to operation 1510 shown in FIG. 15.

In operation 1611, the big data server 510 (for example, a processor, etc. in the big data server 510) may determine whether the item determined in operation 1610 corresponds to at least one reference item for the electronic device 101. The big data server 510 may store information regarding at least one reference item for each electronic device in order to unicast a notification message to each electronic device or in order to grasp preference of the user of each electronic device. The information regarding the at least one reference item may be determined based on the information collected in operation 1602, etc.

The big data server 510 may compare the information regarding the at least one reference item for the electronic device 101, which is stored in the big data server 510, and the information regarding the item determined in operation 1610. The big data server 510 may determine whether the determined item corresponds to the at least one reference item for the electronic device 101 based on the result of comparing. When the determined item corresponds to the at least one reference item for the electronic device 101, the big data server 510 may perform operation 1612.

When the determined item corresponds to the at least one reference item for the electronic device 101, the big data server 510 (for example, a processor, etc. in the big data server 510) may transmit a notification message including the determined information regarding the item to the electronic device 101 in operation 1612. In other words, the big data server 510 may unicast the notification message including the determined information regarding the item to the electronic device 101. The electronic device 101 may receive the notification message including the determined information regarding the item from the big data server 510.

In operation 1613, the electronic device 101 (for example, the processor 120, etc.) may display the received notification message. In operation 1613, the electronic device 101 may perform an operation corresponding to operation 1513.

As described above, the big data server 510 according to various example embodiments may monitor the information collected from the plurality of electronic devices, such that it can provide information suiting a current transaction situation of the item and the user of the electronic device 101 to the electronic device 101. In other words, the big data server 510 may provide information personalized to a user or a situation to the user of the electronic device 101 through the notification message, rather than providing a message having an advertisement.

In addition, the electronic device 101 according to various example embodiments may display the notification message received from the big data server 510, such that the user of the electronic device 101 can shop. In other words, the electronic device 101 can provide an improved shopping environment to the user of the electronic device 101.

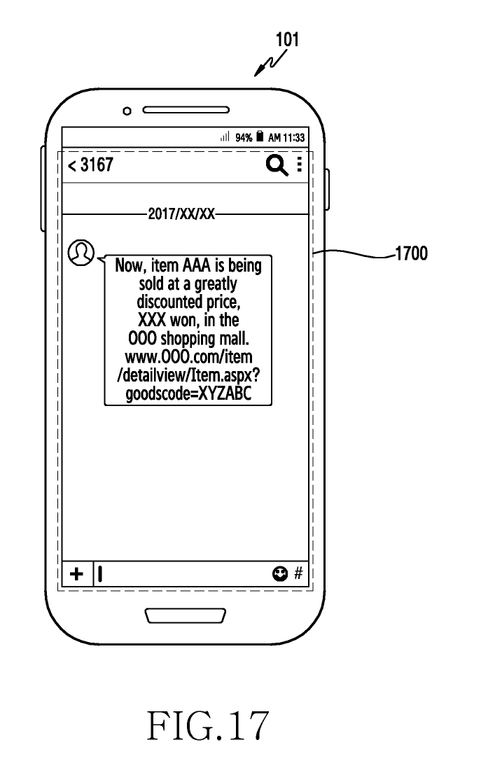

FIG. 17 is a view showing an example of a screen of a notification message displayed on an electronic device according to various example embodiments. This screen may be displayed on the display 160 of the electronic device 101 shown in FIG. 1.

Referring to FIG. 17, the electronic device 101 (for example, the processor 120, the display 160, etc.) which receives the notification message may display a screen 1700. The screen 1700 may include information regarding a specific item which is included in the notification message. For example, the screen 1700 may display a text saying “Now, item AAA is being sold at a greatly discounted price, XXX won, in the OOO shopping mall” and a link “www.OOO.com/item/detailview/Item.aspx?goodscode=XYZABC” connected to a page for buying the item AAA. The user of the electronic device 101 may recognize that the user could buy the item AAA for XXX won which is cheaper than a normal price if the user visits the OOO shopping mall now, through the text. In addition, the user of the electronic device 101 may access the web page for buying the item AAA using the link without conducting a separate search. The electronic device 101 may display the web page for buying the item AAA on the display 160 of the electronic device 101 based on an input on the link being detected. In some example embodiments, the electronic device 101 may display the web page overlapping an entirety or a part of the notification message. In some example embodiments, the electronic device 101 may stop displaying the notification message and may display the web page. However, a method for displaying the web page or the notification message is not limited thereto.

As described above, the electronic device 101 according to various example embodiments provides the notification message having high accessibility to the user, such that it can provide an improved buying environment to the user.

A method of an electronic device according to various example embodiments as described above may include: at least temporarily storing first information on web addresses that the electronic device accesses via a communication circuit of the electronic device; receiving a user input via a display of the electronic device, for executing a transaction using a first application program; upon receiving the user input, transmitting second information associated with the transaction to a first external server via the communication circuit; accessing a web document associated with one of the web addresses immediately before or after transmitting the second information; parsing the web document to obtain at least one item associated with the transaction; and transmitting third information on one or more of the at least one item or one of the web addresses to the outside of the electronic device using the communication circuit.

In some example embodiments, transmitting the third information may include transmitting the third information to a second external server different from the first external server.

In some example embodiments, the web document may be in an HTML format.

In some example embodiments, parsing may include parsing the web document using a rule-based method or a machine-learning based method.

In some example embodiments, the first information may include an URL.

In some example embodiments, the method may include: receiving fourth information via the communication circuit from the external server, wherein the fourth information is generated based at least partly on data associated with web addresses and items, the data being collected from a plurality of electronic devices that include the first application program; and providing a notification on the display, based on the fourth information.

In some example embodiments, the method may further include determining whether a plurality of web addresses accessed by the electronic device through the communication circuit are associated with the transaction, and temporarily storing may include at least temporarily storing the first information on the web address associated with the transaction from among the plurality of webs.

A method of an electronic device according to various example embodiments as described above may include: receiving, from a first external electronic device, a first message for indicating that a first transaction is completed; determining at least one web address including a domain name associated with the transaction, among a plurality of web addresses accessed, by the electronic device, during an interval determined based on a timing at which the first message is received; determining information regarding an item of the first transaction by parsing data regarding at least one web document associated with the at least one web address; and transmitting, to the first external electronic device or a second external electronic device, information regarding the item of the first transaction.

In some example embodiment, the method may further include receiving, from the second external electronic device, information regarding at least one reference item that is determined based on information regarding a plurality of items including the item transmitted from the electronic device. In addition, the method may further include receiving, from the second external electronic device, a second message including information regarding a specific item that is determined based on information collected from a plurality of electronic devices. In addition, the method may further include: determining whether the specific item is included in the at least one reference item; and displaying information regarding the specific item, if the specific item is included in the at least one reference item. In addition, the information regarding the specific item that is displayed may include data for establishing a second transaction regarding the specific item. In addition, the data for establishing the second transaction regarding the specific item may include at least one of: data for indicating a web address providing the specific item; data for indicating an event associated with the specific item; data for indicating a price of the specific item; or data for indicating an image of the specific item.

In addition, the method may further include: accessing a web page for a transaction regarding the specific item, based on detecting an input on the displayed information regarding the specific item; and displaying the web page that is accessed.

In some example embodiments, the second message may be transmitted, from the second external electronic device, if a frequency that the specific item is included in information collected from the plurality of electronic devices during a pre-determined period is greater than or equal to a reference value.

In some example embodiments, the method may further include receiving, from the second external electronic device, a second message including information regarding a specific item that is determined based on information collected from a plurality of electronic devices, and the second message may be transmitted, from the second external electronic device to the electronic device, based on determining that the specific item is included in at least one reference item that is determined based on information regarding a plurality of items including the item transmitted from the electronic device.

In some example embodiments, determining the at least one web address may include, by comparing at least one reference domain name associated with the transaction with domain names of the plurality of web addresses, determining the at least one web address having a domain name corresponding to the at least one reference domain name from among the plurality of web addresses, and the at least one reference domain name may be pre-stored in the electronic device.

In some example embodiments, determining the at least one web address may include: identifying words included in each of the domain names of the plurality of web addresses; determining whether a word generated by combining at least one of the identified words is included in at least one reference word pre-stored in the electronic device and associated with a transaction; and determining, based on determining that the word is included in the at least one reference word, a web address including a domain name including at least one word included in the word as the at least one web address.

In some example embodiments, determining the information regarding the item of the first transaction may include: identifying a tag included in the web document, by parsing data regarding the at least one web document; and determining information regarding the item of the first transaction, based on information included in the tag that is identified.

A method of a server according to various example embodiments as described above may include: receiving, from a plurality of electronic devices, information regarding a plurality of items associated with a transaction; and transmitting, if a frequency that a first item is included in information received from the plurality of electronic devices during a predetermined period is greater than or equal to a reference value, information regarding the first item, and the information regarding the plurality of items are respectively transmitted from the plurality of electronic devices based on completing a transaction regarding each of the plurality of items in each of the plurality of electronic devices.

Methods based on the example embodiments disclosed in the claims or the example embodiments of the present disclosure may be implemented in hardware, software, or a combination of hardware and software.

When implemented in software, a computer readable storage medium for storing one or more programs (software modules) may be provided. The one or more programs stored in the computer readable storage medium are configured for execution performed by one or more processors in an electronic device. The one or more programs include instructions for allowing the electronic device to execute the methods based on the example embodiments disclosed in the claims or the example embodiments of the present invention.

The program (software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may access via an external port to the apparatus performing the exemplary example embodiments of the present disclosure. In addition, a separate storage device on the communication network may access the apparatus performing the exemplary example embodiments of the present disclosure.

In the exemplary example embodiments of the present disclosure described above, the elements included in the present disclosure are expressed in a singular form or a plural form according to an exemplary example embodiment. However, the singular form or plural form is just selected to suit to a suggested situation for the sake of easy explanation, and the present disclosure is not limited to the single or plural elements. Even when an element is expressed in a plural form, the element may be provided as a single element, and, even when an element is expressed in a singular form, the element may be provided as a plurality of elements.

While example embodiments of the invention have been shown and described with reference to certain preferred example embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An electronic device comprising:
a housing;
a touchscreen display exposed through a portion of the housing;
a wireless communication circuit;
a processor electrically connected to the display and the communication circuit; and
a memory electrically connected to the processor, wherein the memory stores a first application program configured to transmit transaction-related information to a first external server via the communication circuit,
wherein the memory further stores instructions that, when executed, are configured to cause the processor to:
at least temporarily store first information on web addresses that the electronic device accessed and/or can access via the communication circuit;
receive a user input via the display for executing a transaction using the first application program;
upon receiving the user input, transmit second information associated with the transaction to the first external server via the communication circuit;
access a web document associated with at least one of the web addresses immediately before and/or after transmitting the information;
parse the web document to obtain at least one item associated with the transaction; and
transmit third information on the at least one of the web addresses and/or the at least one item to outside the electronic device using the communication circuit.

2. The device of claim 1, wherein the instructions are configured to cause the processor to transmit the third information to a second external server different from the first external server.

3. The device of claim 1, wherein the web document is in an HTML, format.

4. The device of claim 1, wherein the instructions are configured to cause the processor to parse the web document using a rule-based method or a machine-learning based method.

5. The device of claim 1, wherein the first information includes a Uniform Resource Locator (URL).

6. The device of claim 1, wherein the instructions are configured to cause the processor to:
receive fourth information via the communication circuit, wherein the fourth information is generated based at least partly on data associated with web addresses and items, the data being collected from a plurality of electronic devices that include the application program; and
provide a notification on the display, based on the fourth information.

7. The device of claim 1, wherein the instructions are configured to cause the processor to:
determine whether a plurality of web addresses accessed by the electronic device are associated with the transaction; and
at least temporarily store the first information on the web address associated with the transaction.

8. An electronic device comprising:
a memory storing instructions;
a wireless communication circuit; and
at least one processor, operably coupled to the memory and the wireless communication circuit, configured to execute the stored instructions to:
receive, from a first external electronic device, a first message for indicating that a first transaction is completed;
determine at least one web address including at least one domain name associated with the transaction, among a plurality of web addresses accessed, by the electronic device, during an interval determined based on a timing at which the first message is received;
determine information regarding an item of the first transaction by parsing data regarding at least one web document associated with the at least one web address; and
transmit, to the first external electronic device and/or to a second external electronic device, information regarding the item of the first transaction.

9. The electronic device of claim 8, wherein the at least one processor is further configured to execute the stored instructions to receive, from the second external electronic device, information regarding at least one reference item that is determined based on information regarding a plurality of items including the item transmitted from the electronic device.

10. The electronic device of claim 9, wherein the at least one processor is further configured to receive, from the second external electronic device, a second message including information regarding a specific item that is determined based on information collected from a plurality of electronic devices.

11. The electronic device of claim 10, further comprising:
a display operably coupled to the at least one processor,
wherein the at least one processor is further configured to execute the stored instructions to:
determine whether the specific item is included in the at least one reference item; and
display, via the display, information regarding the specific item, if the specific item is included in the at least one reference item.

12. The electronic device of claim 11, wherein the information that is displayed via the display includes data for establishing a second transaction regarding the specific item.

13. The electronic device of claim 12, wherein the data for establishing the second transaction includes at least one of:
data for indicating a web address providing the specific item;
data for indicating an event associated with the specific item;
data for indicating a price of the specific item; and
data for indicating an image of the specific item.

14. The electronic device of claim 11, wherein the at least one processor is further configured to execute the stored instructions to:
access a web page for a transaction regarding the specific item, based on detecting an input on the displayed information regarding the specific item;
display the web page that is accessed.

15. The electronic device of claim 10, wherein the at least one processor is configured so that the second message is transmitted, from the second external electronic device, if a frequency that the specific item is included in information collected from the plurality of electronic devices during a pre-determined period.

16. The electronic device of claim 8, wherein the at least one processor is further configured to execute the stored instructions to receive, from the second external electronic device, a second message including information regarding a specific item that is determined based on information collected from a plurality of electronic devices,
wherein the second message is transmitted, from the second external electronic device to the electronic device, based on determining, by the second external electronic device, that the specific item is included in at least one reference item that determined based on information regarding a plurality of items including the item transmitted from the electronic device.

17. The electronic device of claim 8, wherein the at least one processor is configured to execute the stored instructions to determine, by comparing at least one reference domain name associated with the transaction with domain names of the plurality of web addresses, the at least one web address having a domain name corresponding to the at least one reference domain name, and
wherein the at least one reference domain name is pre-stored in the electronic device.

18. The electronic device of claim 8, wherein the at least one processor is configured to execute the stored instructions to:
identify words included in each of the domain names;
determine whether a word generated by combining at least one of the identified words is included in at least one reference word pre-stored in the electronic device; and
determine, based on determining that the word is included in the at least one reference word, a web address including a domain name including at least one word included in the word as the at least one web address.

19. The electronic device of claim 8, wherein the at least one processor is configured to execute the stored instructions to:
identify a tag included in the web document, by parsing data regarding the at least one web document; and
determine information regarding an item of the first transaction, based on information included in the tag that is identified.

20. A server comprising:
at least one processor; and
a memory, operably coupled to the at least one processor, storing instructions to cause the at least one processor to:
receive, from a plurality of electronic devices, information regarding a plurality of items associated with a transaction; and
transmit, if a frequency that a first item is included in information received from the plurality of electronic devices during a pre-determined period is greater than or equal to a reference value, information regarding the first item,
wherein the information regarding the plurality of items are respectively transmitted from the plurality of electronic devices based on completing a transaction regarding each of the plurality of items in each of the plurality of electronic devices.
